(19) United States
(12) Patent Application Publication
(10) Pub. No.: US 2026/0343519 A1
(43) Pub. Date: Oct. 29, 2026

(54) Method and Apparatus in Communication Node Used for Wireless Communication

(71) Applicant: Honor Device Co., Ltd., Shenzhen (CN)

(72) Inventors: Qiaoling Yu, Shenzhen (CN); Xiaobo Zhang, Shenzhen (CN)

(21) Appl. No.: 19/730,018

(22) Filed: Jul. 2, 2026

Related U.S. Application Data
(63) Continuation of application No. PCT/CN2025/070329, filed on Jan. 3, 2025.

(30) Foreign Application Priority Data
Jan. 3, 2024 (CN) 202410008132.2

(51) Int. Cl. H04W 72/044

(52) U.S. Cl. CPC H04W 72/046

(57) ABSTRACT

A communication node measures a reference signal using a plurality of spatial filtering parameters separately, and sends a first wireless signal. A first spatial filtering parameter is used for sending the first wireless signal. The first spatial filtering parameter is one of the plurality of spatial filtering parameters, and reception quality measured on a target path using the plurality of spatial filtering parameters is used for determining the first spatial filtering parameter.

### CROSS-REFERENCE TO RELATED APPLICATIONS

This is a continuation of International Patent Application No. PCT/CN2025/070329, filed on Jan. 3, 2025, which claims priority to Chinese Patent Application No. 202410008132.2, filed on Jan. 3, 2024, both of which are incorporated herein by reference in their entireties.

### TECHNICAL FIELD

This disclosure relates to a transmission method and apparatus in a wireless communication system, and in particular, to a method and apparatus for determining a spatial filtering parameter.

### BACKGROUND

In an existing new radio (NR) protocol, a first path (the first path or the first detected path) is used for calculating a timing advance (T_{ADV}), calculating a user equipment (UE) receive-transmit time difference (UE Rx−Tx time difference), calculating downlink (DL) positioning reference signal (PRS) reference signal received path power (RSRPP), calculating a gNB receive -transmit time difference (gNB Rx−Tx time difference), configuration-based measurement and/or reporting by a target device during an long-term evolution (LTE) Positioning Protocol (LPP) process, and the like. In addition, when a UE determines a spatial filtering parameter for sending a signal, the UE may use a same spatial filtering parameter as that used for receiving a signal based on configuration. For example, the UE may send a sounding reference signal (SRS) using a same spatial filtering parameter as that used for receiving a Synchronization Signal Block (SSB or SS/PBCH block) or Channel State Information-Reference Signal (CSI-RS).

With continuous growth of sensing demands, a trend of integrating sensing and a communication capability in a network is increasing. The ITU-R WP 5D working group has studied an application scenario of an integrated sensing and communication (ISAC) technology for 6G. The technical report 22.837 (Rel-19) “Integrated Sensing and Communication Feasibility Study” released by the 3rd Generation Partnership Project (3GPP) elaborates on 26 different use cases and integrates a potential requirement and a key performance indicator (KPI) for ISAC. The 3GPP RAN 102^{nd} meeting approved a study item (SI) “Study on channel modelling for Integrated Sensing And Communication (ISAC) for NR”. The focus of this study is to define channel modeling that supports the detection and/or tracking of targets, including drones, people both indoors and outdoors, vehicles (at least outdoors), automated guided vehicles (for example, in indoor factories), objects that cause hazards on roads/railways, and the like.

### SUMMARY

Receiving a reference signal using a same spatial filtering parameter and/or sending an uplink signal using a same spatial filtering parameter as that used for receiving a signal make/makes it difficult to reflect information about a path receiving a signal. This is unsuitable for a future, especially next-generation, mobile communication system. For example, when ISAC is introduced, reusing an existing scheme makes it difficult to reflect link information of a detected and/or tracked target.

In view of the foregoing problem, this disclosure provides a solution. For the problem descriptions above, an NR system is used as an example. This disclosure is also applicable to scenarios such as long-term evolution advanced (LTE or LTE-A), or 5G-A, or future 6G systems, to achieve similar technical effects to the NR system. Further, although this disclosure provides specific implementations for a spatial filtering parameter, this disclosure can also be used in a scenario with another filtering parameter, to achieve similar technical effects to the spatial filtering parameter. Further, a unified design scheme used for different scenarios also helps reduce hardware complexity and costs. Further, although this disclosure provides specific implementations for a PRS, this disclosure can also be used in a scenario with another signal such as an ISAC sensing signal, to achieve similar technical effects to the PRS. Further, although an original intention of this disclosure is for a Uu air interface, this disclosure can also be used for a PC5 interface, to achieve similar technical effects to the Uu air interface. Further, although the original intention of this disclosure is for a downlink, this disclosure can also be used for an uplink, to achieve similar technical effects to the downlink. Further, although the original intention of this disclosure is for a terminal-to-station scenario, this disclosure is also applicable to a vehicle-to-everything (V2X) scenario, and communication scenarios between a terminal and a relay and between a relay and a base station, to achieve similar technical effects to the terminal-to-base station scenario. Further, although the original intention of this disclosure is for the terminal-to-base station scenario, this disclosure is also applicable to an integrated access and backhaul (IAB) communication scenario, to achieve similar technical effects to the terminal-to-base station scenario. Further, although the original intention of this disclosure is for a terrestrial network (TN) scenario, this disclosure is also applicable to a non-terrestrial network (NTN) communication scenario, to achieve similar technical effects to the TN scenario. In addition, using a unified solution for different scenarios also helps to reduce hardware complexity and costs.

In an embodiment, interpretation of terminology in this disclosure refers to the definitions in the 3GPP specification protocol TS36 series.

In an embodiment, the interpretation of the terminology in this disclosure refers to the definitions in the 3GPP specification protocol TS38 series.

In an embodiment, the interpretation of the terminology in this disclosure refers to the definitions in the 3GPP specification protocol TS37 series.

It should be noted that, in a case of no conflict, embodiments of any node and features in the embodiments of this disclosure can be applied to any other node. In a case of no conflict, embodiments and features in the embodiments of this disclosure may be arbitrarily combined with each other.

This disclosure discloses a method in a first node used for wireless communication, including measuring a reference signal using a plurality of spatial filtering parameters separately; and sending a first wireless signal, where a first spatial filtering parameter is used for sending the first wireless signal.

The first spatial filtering parameter is one of the plurality of spatial filtering parameters, and reception quality measured on a target path using the plurality of spatial filtering parameters is used for determining the first spatial filtering parameter.

In an embodiment, a problem to be resolved by this disclosure includes how to measure the reference signal.

In an embodiment, a characteristic of the foregoing method includes measuring the reference signal using the plurality of spatial filtering parameters separately.

In an embodiment, a problem to be resolved by this disclosure includes how to reflect information about a path of the reference signal by using the first wireless signal.

In an embodiment, a characteristic of the foregoing method includes sending the first wireless signal using the first spatial filtering parameter.

In an embodiment, a problem to be resolved by this disclosure includes how to determine the first spatial filtering parameter.

In an embodiment, a characteristic of the foregoing method includes the reception quality measured on the target path using the plurality of spatial filtering parameters is used for determining the first spatial filtering parameter.

In an embodiment, a problem to be resolved by this disclosure includes how to send the first wireless signal.

In an embodiment, a characteristic of the foregoing method includes the first spatial filtering parameter is used for sending the first wireless signal.

In an embodiment, the foregoing method enables the first wireless signal to reflect the information about the path receiving the reference signal.

In an embodiment, the foregoing method enables the first wireless signal to reflect link information of a detected and/or tracked target.

In an embodiment, the foregoing method measures the reference signal using the plurality of spatial filtering parameters separately, to improve resolution.

In an embodiment, the foregoing method is easy to implement.

In an embodiment, the foregoing method reduces protocol impact.

In an embodiment, the foregoing method is beneficial for target detection and/or tracking.

According to one aspect of this disclosure, the target path is after a first path measured using the plurality of spatial filtering parameters.

In an embodiment, the foregoing method avoids impact of the first path.

In an embodiment, the foregoing method reduces signaling overheads.

In an embodiment, the foregoing method is beneficial for avoiding feedback for a non-target.

In an embodiment, the foregoing method is beneficial for determining a target.

In an embodiment, the foregoing method improves accuracy of judging a target.

According to one aspect of this disclosure, reception quality measured on a first candidate path set using the plurality of spatial filtering parameters is used for determining the first spatial filtering parameter, the first candidate path set includes a plurality of paths, and the target path is one of the plurality of paths.

In an embodiment, the foregoing method considers impact of the plurality of paths.

In an embodiment, the foregoing method reduces an error rate of target identification.

In an embodiment, the foregoing method further reduces signaling overheads.

In an embodiment, the foregoing method further improves accuracy of determining a target.

According to one aspect of this disclosure, reception quality measured on the target path using the first spatial filtering parameter is not lower than a specific threshold.

In an embodiment, the foregoing method considers precision of the reception quality.

In an embodiment, the foregoing method is beneficial for target identification and/or matching.

In an embodiment, the foregoing method further reduces signaling overheads.

In an embodiment, the foregoing method further improves accuracy of judging a target.

According to one aspect of this disclosure, the reference signal occupies a plurality of multicarrier symbols in time domain, and each of the plurality of spatial filtering parameters is used for receiving the reference signal on at least one multicarrier symbol.

According to one aspect of this disclosure, the following is included: sending first measurement information.

The first measurement information includes a difference between a reception timing of the reference signal and a transmission timing of the first wireless signal.

In an embodiment, the foregoing method is beneficial for determining RTT.

In an embodiment, the foregoing method is beneficial for determining delay information of the reference signal.

In an embodiment, the foregoing method is beneficial for determining delay information of the path of the reference signal.

This disclosure discloses a method in a second node used for wireless communication, including: receiving a first wireless signal, where a first spatial filtering parameter is used by a sender of the first wireless signal for sending the first wireless signal.

The sender of the first wireless signal measures a reference signal using a plurality of spatial filtering parameters separately, the first spatial filtering parameter is one of the plurality of spatial filtering parameters, and reception quality measured on a target path using the plurality of spatial filtering parameters is used by the sender of the first wireless signal for determining the first spatial filtering parameter.

According to one aspect of this disclosure, the target path is after a first path measured using the plurality of spatial filtering parameters.

According to one aspect of this disclosure, reception quality measured on a first candidate path set using the plurality of spatial filtering parameters is used for determining the first spatial filtering parameter, the first candidate path set includes a plurality of paths, and the target path is one of the plurality of paths.

According to one aspect of this disclosure, reception quality measured on the target path using the first spatial filtering parameter is not lower than a specific threshold.

According to one aspect of this disclosure, the reference signal occupies a plurality of multicarrier symbols in time domain, and each of the plurality of spatial filtering parameters is used for receiving the reference signal on at least one multicarrier symbol.

According to one aspect of this disclosure, the following is included: receiving first measurement information.

The first measurement information includes a difference between a reception timing of the reference signal and a transmission timing of the first wireless signal.

According to one aspect of this disclosure, the reference signal is sent.

According to one aspect of this disclosure, second measurement information is sent. The second measurement information includes a difference between a reception timing of a reception frame and a transmission timing of a transmission frame, the reception frame includes the first wireless signal, and the transmission frame is closest to the reception frame in time.

This disclosure discloses a first node used for wireless communication, including: a first receiver configured to measure a reference signal using a plurality of spatial filtering parameters separately; and a first transmitter configured to send a first wireless signal, where a first spatial filtering parameter is used for sending the first wireless signal.

The first spatial filtering parameter is one of the plurality of spatial filtering parameters, and reception quality measured on a target path using the plurality of spatial filtering parameters is used for determining the first spatial filtering parameter.

This disclosure discloses a second node used for wireless communication, including a second transmitter configured to send a reference signal, where a recipient of the reference signal measures the reference signal using a plurality of spatial filtering parameters separately; and a second receiver configured to receive a first wireless signal, where a first spatial filtering parameter is used by the recipient of the reference signal for sending the first wireless signal.

The first spatial filtering parameter is one of the plurality of spatial filtering parameters, and reception quality measured on a target path using the plurality of spatial filtering parameters is used by the recipient of the reference signal for determining the first spatial filtering parameter.

In an embodiment, compared with a conventional solution, this disclosure has the following advantages beneficial for target detection and/or tracking; beneficial for improving accuracy of target identification and/or matching; beneficial for determining delay information of a path of a reference signal; easy to implement; reducing protocol impact; and/or reducing signaling overheads.

### BRIEF DESCRIPTION OF DRAWINGS

Other features, objectives, and advantages of this disclosure may be learned by reading detailed descriptions of non-limiting embodiments with reference to the following drawings:

FIG. 1 is a flowchart of transmission of a reference signal and a first wireless signal according to an embodiment of this disclosure;

FIG. 2 is a schematic diagram of a network architecture according to an embodiment of this disclosure;

FIG. 3 is a schematic diagram of an embodiment of a radio protocol architecture for a user plane and a control plane according to an embodiment of this disclosure;

FIG. 4 is a schematic diagram of a first communication device and a second communication device according to an embodiment of this disclosure;

FIG. 5 is a flowchart of transmission of a wireless signal according to an embodiment of this disclosure;

FIG. 6 is a schematic diagram of a target path after a first path measured using a plurality of spatial filtering parameters according to an embodiment of this disclosure;

FIG. 7 is a schematic diagram in which reception quality measured on a first candidate path set using a plurality of spatial filtering parameters is used for determining a first spatial filtering parameter according to an embodiment of this disclosure;

FIG. 8 is a schematic diagram in which reception quality measured on a target path using a first spatial filtering parameter is not lower than a specific threshold according to an embodiment of this disclosure;

FIG. 9 is a schematic diagram in which a reference signal occupies a plurality of multicarrier symbols in time domain according to an embodiment of this disclosure;

FIG. 10 is a schematic diagram of transmission of a reference signal according to an embodiment of this disclosure;

FIG. 11 is a schematic diagram of a relation between a spatial filtering parameter and a multicarrier symbol occupied by a reference signal according to an embodiment of this disclosure;

FIG. 12 is a block diagram of a structure of a processing apparatus in a first node according to an embodiment of this disclosure; and

FIG. 13 is a block diagram of a structure of a processing apparatus in a second node according to an embodiment of this disclosure.

### DESCRIPTION OF EMBODIMENTS

The technical solutions of this disclosure are further described in detail below with reference to the accompanying drawings. It should be noted that, in a case of no conflict, embodiments and features in the embodiments of this disclosure can be arbitrarily combined with each other.

### Embodiment 1

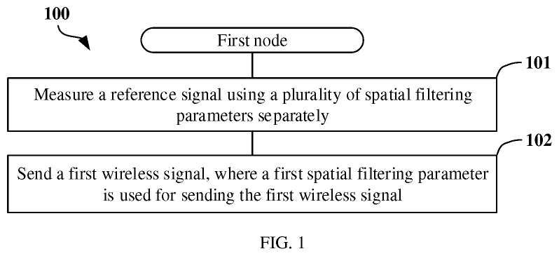

Embodiment 1 illustrates a flowchart of transmission of a reference signal and a first wireless signal according to an embodiment of this disclosure, as shown in FIG. 1. In FIG. 1, each box represents a step, and it should be particularly emphasized that an order of the boxes in the figure does not represent a temporal precedence relation between the represented steps.

In Embodiment 1, a first node in this disclosure, in step 101, measures a reference signal using a plurality of spatial filtering parameters separately; in step 102, sends a first wireless signal, where a first spatial filtering parameter is used for sending the first wireless signal. The first spatial filtering parameter is one of the plurality of spatial filtering parameters, and reception quality measured on a target path using the plurality of spatial filtering parameters is used for determining the first spatial filtering parameter.

In an embodiment, a sender of the reference signal is at least one RAN node.

In an embodiment, the sender of the reference signal is at least one transmission point (TP).

In an embodiment, the reference signal is of a downlink.

In an embodiment, the reference signal is of a sidelink (SL).

In an embodiment, the reference signal is of an uplink.

In an embodiment, the reference signal is used for positioning.

In an embodiment, the reference signal is used for sensing.

In an embodiment, the reference signal is a Reference Signal (RS).

In an embodiment, the reference signal is an SS.

In an embodiment, the reference signal is an SSB.

In an embodiment, the reference signal is a CSI-RS.

In an embodiment, the reference signal is a PRS.

In an embodiment, the reference signal is in quasi-colocation (QCL) with an SSB.

In an embodiment, the reference signal is in QCL with a CSI-RS.

In an embodiment, the reference signal is a sensing signal.

In an embodiment, the reference signal is configured at an RRC sublayer.

In an embodiment, the reference signal is configured by an RRC message.

In an embodiment, the reference signal is configured by an RRCReconfiguration message.

In an embodiment, the reference signal is configured by an RRC message whose name includes RRC and Reconfiguration.

In an embodiment, the reference signal is configured at an LPP layer.

In an embodiment, the reference signal is configured by a PRS CONFIGURATION REQUEST message.

In an embodiment, the reference signal is configured by a MEASUREMENT PRECONFIGURATION REQUIRED message.

In an embodiment, the reference signal is configured by a PRS Configuration IE.

In an embodiment, the reference signal is configured on a cell.

In an embodiment, the reference signal is configured on a BWP.

In an embodiment, the reference signal is configured on a band.

In an embodiment, the reference signal is periodic.

In a sub-embodiment of the foregoing embodiment, the foregoing method reduces signaling overheads.

In a sub-embodiment of the foregoing embodiment, the foregoing method is beneficial for obtaining measurement information of the reference signal in a timely manner.

In an embodiment, the reference signal is semi-persistent.

In a sub-embodiment of the foregoing embodiment, the foregoing method reduces listening time of the first node for the reference signal. This is beneficial for energy saving of the first node.

In a sub-embodiment of the foregoing embodiment, the foregoing method reduces unnecessary sending of the reference signal by the second node. This is beneficial for energy saving of the second node.

In an embodiment, the reference signal is served on demand.

In a sub-embodiment of the foregoing embodiment, the foregoing method is beneficial for energy saving.

In a sub-embodiment of the foregoing embodiment, the foregoing method reduces reference signals sent by the second node. This is beneficial for energy saving of the first node.

In a sub-embodiment of the foregoing embodiment, the foregoing method reduces reference signals measured by the first node. This is beneficial for energy saving of the first node.

In a sub-embodiment of the foregoing embodiment, in response to sending one signal, the reference signal is measured using the plurality of spatial filtering parameters separately.

In a sub-embodiment of the foregoing embodiment, the one signal triggers the reference signal.

In a sub-embodiment of the foregoing embodiment, the one signal is correlated with the reference signal.

In a sub-embodiment of the foregoing embodiment, the one signal is used for requesting the reference signal.

In a sub-embodiment of the foregoing embodiment, the one signal is a physical layer signal.

In a sub-embodiment of the foregoing embodiment, the one signal is a wake-up signal (WUS).

In a sub-embodiment of the foregoing embodiment, the one signal occupies a PUCCH.

In a sub-embodiment of the foregoing embodiment, the one signal occupies a physical random access channel (PRACH).

In a sub-embodiment of the foregoing embodiment, the one signal occupies a physical downlink control channel (PDCCH).

In an embodiment, the reference signal is only one reference signal.

In a sub-embodiment of the foregoing embodiment, the first node measures the only one reference signal using the plurality of spatial filtering parameters separately.

In a sub-embodiment of the foregoing embodiment, the foregoing method is beneficial for improving performance of a spatial filtering parameter.

In a sub-embodiment of the foregoing embodiment, the foregoing method is beneficial for precision of positioning.

In a sub-embodiment of the foregoing embodiment, the foregoing method is beneficial for improving resolution.

In a sub-embodiment of the foregoing embodiment, the foregoing method is beneficial for obtaining and feeding back multipath information.

In a sub-embodiment of the foregoing embodiment, the foregoing method is beneficial for positioning of a target.

In a sub-embodiment of the foregoing embodiment, the foregoing method is beneficial for tracking of a target.

In an embodiment, the reference signal is a plurality of reference signals.

In a sub-embodiment of the foregoing embodiment, the first node measures the plurality of reference signals using the plurality of spatial filtering parameters separately.

In a sub-embodiment of the foregoing embodiment, reference signals measured using any two spatial filtering parameters of the plurality of spatial filtering parameters are different.

In a sub-embodiment of the foregoing embodiment, there are two spatial filtering parameters in the plurality of spatial filtering parameters, and reference signals measured using the two spatial filtering parameters are the same.

In a sub-embodiment of the foregoing embodiment, one reference signal is measured using one spatial filtering parameter of the plurality of spatial filtering parameters.

In a sub-embodiment of the foregoing embodiment, one reference signal is measured using multiple spatial filtering parameters in the plurality of spatial filtering parameters.

In a sub-embodiment of the foregoing embodiment, a plurality of reference signals are measured using one spatial filtering parameter in the plurality of spatial filtering parameters.

In an embodiment, the reference signal is at least one reference signal.

In an embodiment, the measurement includes monitoring.

In an embodiment, the measurement includes detecting.

In an embodiment, the measurement includes receiving.

In an embodiment, the measurement is L1 measurement.

In an embodiment, the measurement is reference signal received power (RSRP) measurement.

In an embodiment, the measurement is RSRPP measurement.

In an embodiment, the measurement is signal-to-interference-plus-noise ratio (SINR) measurement.

In an embodiment, the measurement is signal-to-noise ratio (SNR) measurement.

In an embodiment, the measurement is mean square error (MSE) measurement.

In an embodiment, the measurement is time measurement.

In an embodiment, the measurement is timing measurement.

In an embodiment, the measurement is beam level measurement.

In an embodiment, the measurement is path level measurement.

In an embodiment, the path is an arrival path.

In an embodiment, the path is a time path.

In an embodiment, the path is a traveling path.

In an embodiment, the path is a multipath.

In an embodiment, the path arrives within a given time interval.

In an embodiment, arrival time of the path does not exceed the given time interval.

In an embodiment, the path is a received quantity within the given time interval.

In an embodiment, the given time interval is configurable.

In an embodiment, the given time interval is predefined.

In an embodiment, the given time interval depends on a sampling rate.

In an embodiment, the given time interval depends on a subcarrier spacing.

In an embodiment, the measuring the reference signal refers to: measuring at least one path of the reference signal.

In an embodiment, the measuring the reference signal refers to: measuring a plurality of paths of the reference signal.

In an embodiment, the measuring the reference signal refers to: measuring each path of the reference signal.

In an embodiment, the measuring the reference signal refers to: measuring at least a first path of the reference signal.

In an embodiment, the first path of the reference signal is a path of the reference signal that is detected earliest.

In an embodiment, the first path of the reference signal is a path of the reference signal that is detected first in time.

In an embodiment, the first path of the reference signal is a line-of-sight (LOS) path.

In an embodiment, the first node assumes that the first path of the reference signal is a LOS path.

In an embodiment, the first path of the reference signal is a non-line-of-sight (NLOS) path.

In an embodiment, the first path refers to a first path measured using the plurality of spatial filtering parameters.

In an embodiment, the measuring the reference signal refers to: measuring the first path and at most K1 paths of the reference signal, where K1 is an integer.

In an embodiment, K1 is a positive integer.

In an embodiment, K1 is a non-negative integer.

In an embodiment, K1 is predefined.

In an embodiment, K1 is configurable.

In an embodiment, K1 is 8.

In an embodiment, K1 is 7.

In an embodiment, any spatial filtering parameter in the plurality of spatial filtering parameters corresponds to a beam.

In an embodiment, any spatial filtering parameter in the plurality of spatial filtering parameters corresponds to a digital beam.

In an embodiment, any spatial filtering parameter in the plurality of spatial filtering parameters corresponds to an analog beam.

In an embodiment, any spatial filtering parameter in the plurality of spatial filtering parameters corresponds to a transmission configuration indicator (TCI) state.

In an embodiment, any spatial filtering parameter in the plurality of spatial filtering parameters corresponds to a TCI state of a reference signal.

In an embodiment, any spatial filtering parameter in the plurality of spatial filtering parameters is a filter.

In an embodiment, any spatial filtering parameter in the plurality of spatial filtering parameters is a digital filter.

In an embodiment, any spatial filtering parameter in the plurality of spatial filtering parameters is an analog filter.

In an embodiment, any spatial filtering parameter in the plurality of spatial filtering parameters is configured.

In an embodiment, any spatial filtering parameter in the plurality of spatial filtering parameters is configured at the RRC sublayer.

In an embodiment, any spatial filtering parameter in the plurality of spatial filtering parameters is configured at the LPP layer.

In an embodiment, any spatial filtering parameter in the plurality of spatial filtering parameters is determined by UE implementation.

In an embodiment, any spatial filtering parameter in the plurality of spatial filtering parameters includes a configuration parameter of a filter.

In an embodiment, any spatial filtering parameter in the plurality of spatial filtering parameters is a configuration parameter of a filter.

In an embodiment, any spatial filtering parameter in the plurality of spatial filtering parameters includes a coefficient of a filter.

In an embodiment, any spatial filtering parameter in the plurality of spatial filtering parameters is a coefficient of a filter.

In an embodiment, any spatial filtering parameter in the plurality of spatial filtering parameters includes a coefficient of a filter.

In an embodiment, any spatial filtering parameter in the plurality of spatial filtering parameters is a coefficient of a filter.

In an embodiment, any spatial filtering parameter in the plurality of spatial filtering parameters is a spatial filter.

In an embodiment, any spatial filtering parameter in the plurality of spatial filtering parameters is a spatial domain filter.

In an embodiment, any spatial filtering parameter in the plurality of spatial filtering parameters is a receive filter.

In an embodiment, any spatial filtering parameter in the plurality of spatial filtering parameters is a spatial domain receive filter.

In an embodiment, any spatial filtering parameter in the plurality of spatial filtering parameters is a downlink spatial domain transmission filter.

In an embodiment, any spatial filtering parameter in the plurality of spatial filtering parameters is a spatial domain transmission filter.

In an embodiment, any spatial filtering parameter in the plurality of spatial filtering parameters is a downlink receive spatial filter (DL RX spatial filter).

In an embodiment, the reference signal is measured within a specific time interval.

In an embodiment, the reference signal is measured in a first time window.

In an embodiment, the first time window is an sensing processing window (SPW).

In an embodiment, the first time window is a PRS processing window (PPW).

In an embodiment, a length of the first time window is determined by the first node.

In an embodiment, the length of the first time window is requested by the first node.

In an embodiment, the length of the first time window is configured at the RRC sublayer.

In an embodiment, the length of the first time window is configured at the LPP layer.

In an embodiment, the first time window is periodically configured.

In an embodiment, the first time window is event-triggered.

In an embodiment, a start moment of the first time window depends on RRC configuration.

In an embodiment, the start moment of the first time window depends on a plurality of multicarrier symbols, the reference signal occupies the plurality of multicarrier symbols in time domain, and each of the plurality of spatial filtering parameters is used for receiving the reference signal on at least one multicarrier symbol.

In an embodiment, the start moment of the first time window depends on a MAC CE.

In an embodiment, the start moment of the first time window depends on a sending end moment of the one signal; and in response to sending the one signal, the reference signal is measured using the plurality of spatial filtering parameters separately.

In an embodiment, the reference signal is measured simultaneously using the plurality of spatial filtering parameters separately.

In an embodiment, the reference signal is measured within different time intervals using the plurality of spatial filtering parameters separately.

In an embodiment, the reference signal is measured in a TDM manner using the plurality of spatial filtering parameters separately.

In an embodiment, a recipient of the first wireless signal is a base station.

In an embodiment, the recipient of the first wireless signal is a reception point (RP).

In an embodiment, the first wireless signal is of a downlink.

In an embodiment, the first wireless signal is of an uplink.

In an embodiment, the first wireless signal is of a sidelink.

In an embodiment, the first wireless signal is a physical signal.

In an embodiment, the first wireless signal is a physical layer signal.

In an embodiment, the first wireless signal is a Sounding Reference Signal.

In an embodiment, the first wireless signal is an ISAC Reference Signal (IRS).

In an embodiment, the first wireless signal is a Sensing Reference Signal.

In an embodiment, the first wireless signal is a sensing signal.

In an embodiment, the first wireless signal is used for positioning.

In an embodiment, the first wireless signal is used for detection.

In an embodiment, the first wireless signal is correlated with the reference signal.

In an embodiment, at least one of a time domain resource, a frequency domain resource, and a code domain resource occupied by the first wireless signal is configuration-dependent.

In an embodiment, at least one of the time domain resource, the frequency domain resource, and the code domain resource occupied by the first wireless signal is RRC-configured.

In an embodiment, at least one of the time domain resource, the frequency domain resource, and the code domain resource occupied by the first wireless signal is configured by an RRCReconfiguration message.

In an embodiment, at least one of the time domain resource, the frequency domain resource, and the code domain resource occupied by the first wireless signal is configured by an RRC message whose name includes RRC and Reconfiguration.

In an embodiment, at least one of the time domain resource, the frequency domain resource, and the code domain resource occupied by the first wireless signal is LPP-configured.

In an embodiment, at least one of the time domain resource, the frequency domain resource, and the code domain resource occupied by the first wireless signal is configured by a MEASUREMENT REQUEST message.

In an embodiment, at least one of the time domain resource, the frequency domain resource, and the code domain resource occupied by the first wireless signal is configured by a MEASUREMENT UPDATE message.

In an embodiment, at least one of the time domain resource, the frequency domain resource, and the code domain resource occupied by the first wireless signal is configured by a Positioning SRS Resource IE.

In an embodiment, at least one of the time domain resource, the frequency domain resource, and the code domain resource occupied by the first wireless signal is configured by an SRS Configuration IE.

In an embodiment, at least one of the time domain resource, the frequency domain resource, and the code domain resource occupied by the first wireless signal is configured for the reference signal.

In an embodiment, at least one of the time domain resource, the frequency domain resource, and the code domain resource occupied by the first wireless signal is configured for the first node.

In an embodiment, at least one of the time domain resource, the frequency domain resource, and the code domain resource occupied by the first wireless signal depends on the reference signal.

In an embodiment, at least one of the frequency domain resource and the code domain resource occupied by the first wireless signal is the same as the reference signal.

In an embodiment, the code domain resource occupied by the first wireless signal is correlated with a code domain resource occupied by the reference signal.

In an embodiment, a start moment of the time domain resource occupied by the first wireless signal depends on an end moment of the time domain resource occupied by the reference signal.

In an embodiment, the start moment of the time domain resource occupied by the first wireless signal is the end moment of the time domain resource occupied by the reference signal.

In an embodiment, the start moment of the time domain resource occupied by the first wireless signal is a first symbol after the end moment of the time domain resource occupied by the reference signal, where T1 is predefined, or T1 is default, or T1 is configured.

In an embodiment, the code domain resource is a sequence.

In an embodiment, the code domain resource is an RS sequence.

In an embodiment, the code domain resource is a ZC sequence.

In an embodiment, the code domain resource is a scrambling sequence.

In an embodiment, the phrase that the first spatial filtering parameter is used for sending the first wireless signal refers to a spatial filtering parameter used for sending the first wireless signal depends on the first spatial filtering parameter.

In an embodiment, the phrase that the first spatial filtering parameter is used for sending the first wireless signal refers to a spatial filtering parameter used for sending the first wireless signal is determined by the first spatial filtering parameter.

In an embodiment, the phrase that the first spatial filtering parameter is used for sending the first wireless signal refers to a spatial filtering parameter used for sending the first wireless signal is the same as the first spatial filtering parameter.

In an embodiment, the phrase that the first spatial filtering parameter is used for sending the first wireless signal refers to the first node determines that a spatial filtering parameter for sending the first wireless signal is the first spatial filtering parameter.

In an embodiment, the phrase that the first spatial filtering parameter is used for sending the first wireless signal refers to the first node assumes that a spatial filtering parameter for sending the first wireless signal is the same as the first spatial filtering parameter.

In an embodiment, the phrase that the first spatial filtering parameter is used for sending the first wireless signal refers to send the first wireless signal, the first node uses a same spatial filtering parameter as the first spatial filtering parameter.

In a sub-embodiment of the foregoing embodiment, the “use” refers to can use.

In a sub-embodiment of the foregoing embodiment, the “use” refers to: may use.

In a sub-embodiment of the foregoing embodiment, the “use” refers to: shall use.

In a sub-embodiment of the foregoing embodiment, the first spatial filtering parameter is a spatial filtering parameter for sending the first wireless signal.

In a sub-embodiment of the foregoing embodiment, the spatial filtering parameter of the first wireless signal is the same as the first spatial filtering parameter.

In an embodiment, measuring the target path of the reference signal using the plurality of spatial filtering parameters triggers the first wireless signal.

In an embodiment, under an assumption that only a first path of the reference signal is measured using the plurality of spatial filtering parameters and the first path is an LOS path, the measured reference signal does not trigger any wireless signal.

In an embodiment, under an assumption that only the first path of the reference signal is measured using the plurality of spatial filtering parameters, the measured reference signal does not trigger any wireless signal.

In an embodiment, the foregoing method is beneficial for reducing signaling overheads of the first node.

In an embodiment, the first spatial filtering parameter corresponds to a beam.

In an embodiment, the first spatial filtering parameter corresponds to a digital beam.

In an embodiment, the first spatial filtering parameter corresponds to an analog beam.

In an embodiment, the first spatial filtering parameter corresponds to a TCI state.

In an embodiment, the first spatial filtering parameter corresponds to a TCI state of the first wireless signal.

In an embodiment, the TCI state of the first wireless signal is a TCI-UL-State.

In an embodiment, the TCI state of the first wireless signal is a TCI-State in dl-OrJoint-TCIStateList.

In an embodiment, the first spatial filtering parameter corresponds to a QCL relation state.

In an embodiment, the first spatial filtering parameter is a filter.

In an embodiment, the first spatial filtering parameter is a digital filter.

In an embodiment, the first spatial filtering parameter is an analog filter.

In an embodiment, the first spatial filtering parameter is a parameter of a filter.

In an embodiment, the first spatial filtering parameter is a coefficient of a filter.

In an embodiment, the first spatial filtering parameter is a spatial filter.

In an embodiment, the first spatial filtering parameter is a spatial domain filter.

In an embodiment, the first spatial filtering parameter is a spatial domain transmission filter.

In an embodiment, the first spatial filtering parameter is a transmission filter.

In an embodiment, the first spatial filtering parameter is an uplink spatial domain transmission filter.

In an embodiment, the first spatial filtering parameter is a spatial transmission filter.

In an embodiment, the first spatial filtering parameter is a spatial domain transmission filter.

In an embodiment, the first spatial filtering parameter is an uplink transmit spatial filter (UL TX spatial filter).

In an embodiment, a meaning of the first spatial filtering parameter being one of the plurality of spatial filtering parameters includes determining the first spatial filtering parameter from the plurality of spatial filtering parameters.

In a sub-embodiment of the foregoing embodiment, the first node determines the first spatial filtering parameter from the plurality of spatial filtering parameters.

In a sub-embodiment of the foregoing embodiment, the second node determines the first spatial filtering parameter from the plurality of spatial filtering parameters.

In an embodiment, the meaning of the first spatial filtering parameter being one of the plurality of spatial filtering parameters includes: the first spatial filtering parameter is the same as one of the plurality of spatial filtering parameters.

In an embodiment, the first spatial filtering parameter being one of the plurality of spatial filtering parameters refers to: the first spatial filtering parameter is the same as one of the plurality of spatial filtering parameters.

In an embodiment, the reception quality is L1-filtered.

In an embodiment, the reception quality is L3-filtered.

In an embodiment, the reception quality is filtered.

In an embodiment, the reception quality is matched-filtered.

In an embodiment, the reception quality is Wiener-filtered.

In an embodiment, the reception quality is pulse-shaping filtered.

In an embodiment, the reception quality is rectangular-filtered.

In an embodiment, the reception quality is a delay.

In an embodiment, the reception quality is Doppler spread.

In an embodiment, the reception quality is RSRP.

In an embodiment, the reception quality is an SINR.

In an embodiment, the reception quality is an SNR.

In an embodiment, the reception quality is an MSE.

In an embodiment, that the reception quality measured on the target path using the plurality of spatial filtering parameters is used for determining the first spatial filtering parameter refers to: the reception quality measured on the target path using the plurality of spatial filtering parameters is used for determining the first spatial filtering parameter from the plurality of spatial filtering parameters.

In an embodiment, that the reception quality measured on the target path using the plurality of spatial filtering parameters is used for determining the first spatial filtering parameter refers to: a plurality of paths of the reference signal are measured using at least one spatial filtering parameter in the plurality of spatial filtering parameters, and only the reception quality of the target path in the plurality of paths is used for determining the first spatial filtering parameter.

In an embodiment, that the reception quality measured on the target path using the plurality of spatial filtering parameters is used for determining the first spatial filtering parameter refers to: a plurality of paths of the reference signal are measured using only one spatial filtering parameter in the plurality of spatial filtering parameters, and only the reception quality of the target path in the plurality paths is used for determining the first spatial filtering parameter.

In an embodiment, that the reception quality measured on the target path using the plurality of spatial filtering parameters is used for determining the first spatial filtering parameter refers to: a plurality of paths of the reference signal are measured using multiple spatial filtering parameters in the plurality of spatial filtering parameters separately, and only the reception quality of the target path in the plurality of paths is used for determining the first spatial filtering parameter.

In an embodiment, the reception quality of the reference signal measured using the plurality of spatial filtering parameters is not used for determining the first spatial filtering parameter.

In an embodiment, the reception quality of the reference signal measured using the plurality of spatial filtering parameters depends on reception quality of the reference signal measured using each of the plurality of spatial filtering parameters.

In an embodiment, the reception quality of the reference signal measured using the plurality of spatial filtering parameters depends on reception quality of the reference signal measured using all spatial filtering parameters in the plurality of spatial filtering parameters.

In an embodiment, the sensing signal is used for tracking a target.

In an embodiment, the sensing signal is used for detecting a target.

In an embodiment, the sensing signal is used for positioning.

In an embodiment, the sensing signal is an ISAC sensing signal.

In an embodiment, the sensing signal is a sensing reference signal.

In an embodiment, the sensing signal is a sensing physical signal.

In an embodiment, the sensing signal is a sensing pulse.

In an embodiment, the sensing signal is a chirp signal.

In an embodiment, the sensing signal is a set of chirp signals.

In an embodiment, the sensing signal is a chirp chip.

In an embodiment, the sensing signal is a set of chirp chips.

In an embodiment, the sensing signal occupies at least one orthogonal frequency division multiplexing (OFDM) Resource Element (RE).

In an embodiment, the sensing signal occupies at least one OFDM time-frequency unit.

In an embodiment, the sensing signal occupies at least one OTFS RE.

In an embodiment, the sensing signal occupies at least one OTFS delay-Doppler unit.

In an embodiment, the sensing signal occupies at least one frequency modulated continuous wave (FMCW) RE.

In an embodiment, the sensing signal occupies at least one FMCW delay-Doppler unit.

In an embodiment, the sensing signal occupies a set of OFDM REs.

In an embodiment, the sensing signal occupies a set of OFDM time-frequency units.

In an embodiment, the sensing signal occupies a set of orthogonal time frequency space modulation (OTFS) REs.

In an embodiment, the sensing signal occupies a set of OTFS delay-Doppler units.

In an embodiment, the sensing signal occupies a set of FMCW REs.

In an embodiment, the sensing signal occupies a set of FMCW delay-Doppler units.

In an embodiment, the sensing signal occupies at least one sensing signal transmission symbol.

In an embodiment, the “assume” in this disclosure can be a “can assume”, or a “may assume”, or a “shall assume”, or a “should assume”, or a similar concept. Further, the “assume” in this disclosure can be equivalently replaced with “consider”, “regard as”, or a similar concept. Further, a meaning of the “assume” in this disclosure may vary in different embodiments.

### Embodiment 2

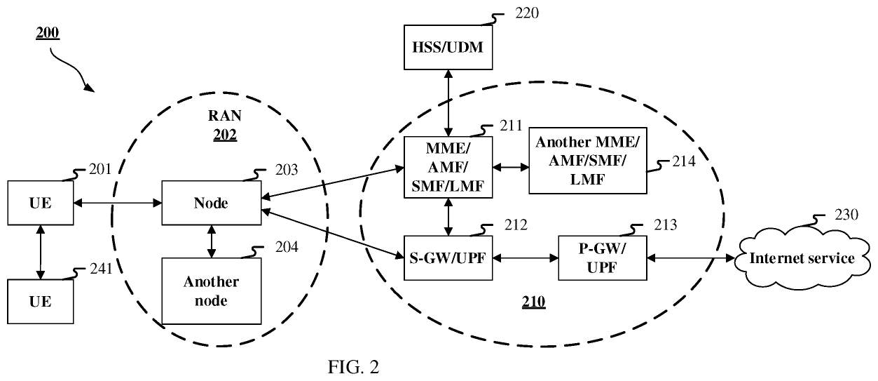

Embodiment 2 illustrates a schematic diagram of a network architecture according to an embodiment of this disclosure, as shown in FIG. 2. FIG. 2 describes a network architecture 200. The network architecture 200 is a 5G new radio/long-term evolution (NR/LTE)/long-term evolution advanced (LTE-A) system, or the network architecture 200 is a 5G+ network architecture, or the network architecture 200 is a 6G network architecture, or the network architecture 200 is a network architecture that 3GPP continues to evolve in the future. The network architecture 200 may be referred to as a 5G System)/evolved packet system (5GS/EPS), or the network architecture 200 can be referred to as a 6G System (6GS). The network architecture 200 includes at least one of a user equipment (UE) 201, a radio access network (RAN) 202, a core network 210, a home subscriber server/unified data management (HSS/UDM) 220, and an internet service 230. The network architecture 200 can be interconnected with another access network, but these entities/interfaces are not shown for simplicity. As shown in the figure, the network architecture 200 provides a packet switching service. However, those skilled in the art will readily understand that the various concepts presented throughout this disclosure can be extended to a network providing a circuit switching service or another cellular network. The RAN includes a node 203 and another node 204. The node 203 provides user and control plane protocol termination towards the UE 201. The node 203 may be connected to the another node 204 through an Xn interface (for example, backhaul)/X2 interface. The node 203 may also be referred to as a base station, a base transceiver station, a radio base station, a radio transceiver, a transceiver function, a basic service set (BSS), an extended service set (ESS), a transmission reception point (TRP), or some other suitable terminology. The core network 210 is a 5G Core Network/evolved packet core (5G core network, 5GC/EPC), or the core network 210 is a 6GC. The node 203 provides an access point to the core network 210 for the UE 201. Instances of the UE 201 include a cellular phone, a smartphone, a session initiation protocol (SIP) phone, a laptop computer, a personal digital assistant (PDA), satellite radio, non-terrestrial base station communication, satellite mobile communication, a global positioning system, a multimedia apparatus, a video apparatus, a digital audio player (for example, an MP3 player), a camera, a game console, a drone, a flying machine, a narrowband internet of things device, a machine type communication device, a terrestrial vehicle, an automobile, a wearable device, or any other apparatus having a similar function. A person skilled in the art may also refer to the UE 201 as a mobile station, a subscriber station, a mobile unit, a subscriber unit, a wireless unit, a remote unit, a mobile apparatus, a wireless apparatus, a wireless communication apparatus, a remote apparatus, a mobile subscriber station, an access terminal, a mobile terminal, a wireless terminal, a remote terminal, a handset, a user agent, a mobile client, a client, or some other suitable terminology. The node 203 is connected to the core network 210 through an S1/NG interface. The core network 210 includes a mobility management entity/authentication management field/session management function/location management function (MME/AMF/SMF/LMF) 211, another MME/AMF/SMF/LMF 214, a service gateway/user plane function (S-GW/UPF) 212, and a packet data network gateway (P-GW)/UPF 213. The MME/AMF/SMF/LMF 211 is a control node that processes signaling between the UE 201 and the core network 210. Generally, the MME/AMF/SMF/LMF 211 provides bearer and connection management. All user internet protocol (IP) packets are transmitted through the S-GW/UPF 212, and the S-GW/UPF 212 itself is connected to the P-GW/UPF 213. The P-GW provides UE IP address allocation and another function. The P-GW/UPF 213 is connected to the internet service 230. The internet service 230 includes an operator-corresponding internet protocol service, which may specifically include an internet, an intranet, a IP Multimedia Subsystem (IP multimedia subsystem, IMS), and a packet switching streaming service.

In an embodiment, the UE 201 is a user equipment (UE).

In an embodiment, the UE 201 is a base station (BS) device.

In an embodiment, the UE 201 is a relay device.

In an embodiment, the UE 201 is a gateway device.

In an embodiment, the UE 201 is a target device.

In an embodiment, the target device is a UE.

In an embodiment, the target device is an SET.

In an embodiment, the UE 201 supports an LPP.

In an embodiment, the UE 201 supports an NR Positioning Protocol (NRPP).

In an embodiment, the UE 201 supports an NR Positioning Protocol A (NRPPa).

In an embodiment, the UE 201 supports a sensing Positioning Protocol (SPP).

In an embodiment, the UE 201 supports sensing.

In an embodiment, the UE 201 supports bistatic sensing.

In an embodiment, the UE 201 supports monostatic sensing.

In an embodiment, the UE 201 supports beam sweeping.

In an embodiment, the UE 201 supports measuring a reference signal using a plurality of spatial filtering parameters separately.

In an embodiment, the node 203 corresponds to the second node in this disclosure.

In an embodiment, the node 203 is a base station device.

In an embodiment, the node 203 is a user equipment.

In an embodiment, the node 203 is a relay device.

In an embodiment, the node 203 is a gateway device.

In an embodiment, the node 203 is a location server.

In an embodiment, the location server includes an LMF.

In an embodiment, the location server includes an SLP.

In an embodiment, the location server is at least one of an E-SMLC, an LMF, or an SLP.

In an embodiment, the user equipment supports low-latency and high-reliability transmission.

In an embodiment, the user equipment supports at least one of a non-terrestrial network (NTN) or a terrestrial network.

In an embodiment, the user equipment supports dual connection (DC).

In an embodiment, the user equipment supports ISAC.

In an embodiment, the user equipment is a mobile terminal.

In an embodiment, the user equipment is a mobile phone or a tablet.

In an embodiment, the user equipment is a flying machine.

In an embodiment, the user equipment is an internet of things device, and the internet of things device is an internet of things terminal, a vehicle-mounted terminal, a ship, or an industrial internet of things terminal.

In an embodiment, the user equipment is a test device or a signaling tester.

In an embodiment, the user equipment is an Integrated Access and Backhaul (IAB)-MT.

In an embodiment, the base station device supports transmission in a non-terrestrial network.

In an embodiment, the base station device supports transmission in a terrestrial network.

In an embodiment, the base station device is a macro cellular base station, a micro cell base station, a pico cell base station, or a femtocell. The base station device is a base transceiver station (BTS), a NodeB (NB), a gNB, an eNB, an ng-eNB, or an en-gNB.

In an embodiment, the base station device includes at least one of a central unit (CU), a distributed unit (DU), or a transmission reception point (TRP).

In an embodiment, the base station device is an aerial node, and the aerial node is a flight platform device, a satellite device, or an NTN base station.

In an embodiment, the base station device is a test device or a signaling tester.

In an embodiment, the base station device is a gateway device.

In an embodiment, the base station device is a RAN node.

In an embodiment, the RAN node is an NG-RAN node.

In an embodiment, the RAN node is a gNB.

In an embodiment, the RAN node is an ng-eNB.

In an embodiment, the RAN node is a NodeB.

In an embodiment, the RAN node is an eNodeB.

In an embodiment, the base station device is an IAB node, and the IAB node is an IAB-donor, an IAB-donor-CU, an IAB-donor-DU, an IAB-DU, or an IAB-MT.

In an embodiment, the relay device is a relay, and the relay is an L3 relay, an L2 relay, or an L1 relay.

In an embodiment, the relay device is a router.

In an embodiment, the relay device is an RIS.

In an embodiment, the relay device is a switch or a gateway device.

In an embodiment, the relay device is a user equipment.

In an embodiment, the relay device is a network device.

### Embodiment 3

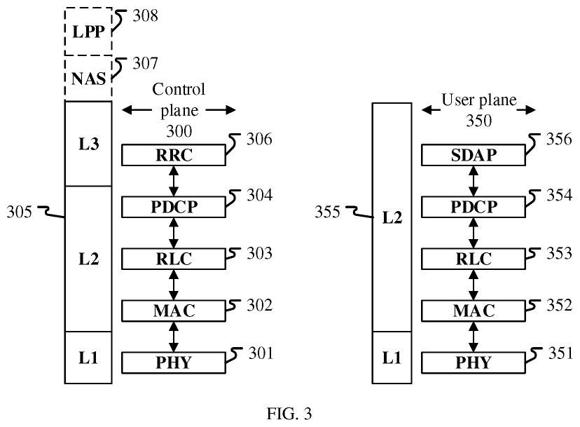

Embodiment 3 illustrates a schematic diagram of an embodiment of radio protocol architectures for a user plane and a control plane according to this disclosure, as shown in FIG. 3. FIG. 3 is a schematic diagram describing the embodiment of the radio protocol architectures used for the user plane 350 and the control plane 300, and FIG. 3 shows a radio protocol architecture used for the control plane 300 with at least a layer 1, a layer 2, and a layer 3. The layer 1 (L1 layer) is a lowest layer and implements various physical layer (PHY) signal processing functions. The L1 layer is referred to as a PHY 301 herein. The layer 2 (L2 layer) 305 is above the PHY 301 and includes a medium access control (MAC) sublayer 302, a radio link control (RLC) sublayer 303, and a packet data convergence protocol (PDCP) sublayer 304. The PDCP sublayer 304 provides multiplexing between different radio bearers and logical channels. The PDCP sublayer 304 also provides security by encrypting a data packet, and provides inter-cell mobility support. The RLC sublayer 303 provides segmentation and reassembly of an upper layer packet, retransmission of a lost packet, and reordering of packets to compensate for out-of-order receiving due to a hybrid automatic repeat request (HARQ). The MAC sublayer 302 provides multiplexing between logical and transmission channels. The MAC sublayer 302 is also responsible for allocating various radio resources (for example, resource blocks) in a cell. The MAC sublayer 302 is also responsible for a HARQ operation. A radio resource control (RRC) sublayer 306 at the layer 3 (L3 layer) of the control plane 300 is responsible for obtaining a radio resource (for example, a radio bearer) and configuring a lower layer using RRC signaling. A radio protocol architecture for the user plane 350 includes a layer 1 (L1 layer) and a layer 2 (L2 layer). In the user plane 350, the radio protocol architecture for a physical layer 351, a PDCP sublayer 354 at the L2 layer 355, an RLC sublayer 353 at the L2 layer 355, and a MAC sublayer 352 at the L2 layer 355 is largely the same as corresponding layers and sublayers in the control plane 300, but the PDCP sublayer 354 also provides header compression for an upper layer packet to reduce radio transmission overheads. The L2 layer 355 in the user plane 350 also includes a service data adaptation protocol (SDAP) sublayer 356, and the SDAP sublayer 356 is responsible for mapping between a QoS flow and a data radio bearer (DRB) to support service diversity.

In an embodiment, the radio protocol architecture in FIG. 3 is applicable to the first node described in this disclosure.

In an embodiment, the radio protocol architecture in FIG. 3 is applicable to the second node described in this disclosure.

In an embodiment, the reference signal in this disclosure is generated at the PHY 301 or PHY 351.

In an embodiment, the first wireless signal in this disclosure is generated at the PHY 301 or PHY 351.

In an embodiment, the first measurement information in this disclosure is generated at the RRC sublayer 306.

In an embodiment, the radio protocol architecture for the control plane 300 may also include a non access stratum (NAS) layer 307.

In an embodiment, the NAS layer 307 is responsible for supporting mobility of a user equipment (UE) (including common procedures such as authentication, identification, a common UE configuration update, and a security mode control procedure), and/or supporting session management procedures to establish and maintain data connectivity between a terminal and a data network, and/or providing SMS, LPP, LCS, UE policy containers, an SOR transparent container, and a UE parameter update information payload.

In an embodiment, the first measurement information in this disclosure is generated at the NAS layer 307.

In an embodiment, the radio protocol architecture for the control plane 300 may also include an LPP layer 308.

In an embodiment, the LPP layer 308 is used in a point-to-point manner between a location server (an E-SMLC, an LMF, or an SLP) and a target device (UE or a SET), to position the target device using location-related measurement values obtained from one or more reference sources.

In an embodiment, the first measurement information in this disclosure is generated at the LPP layer 308.

In a sub-embodiment of the foregoing embodiment, a higher layer is the NAS layer 307.

In a sub-embodiment of the foregoing embodiment, the higher layer is the LPP layer 308.

In an embodiment, the first measurement information in this disclosure is generated at the MAC sublayer 302 or the MAC sublayer 352.

In an embodiment, the first measurement information in this disclosure is generated at the PHY 301 or the PHY 351.

### Embodiment 4

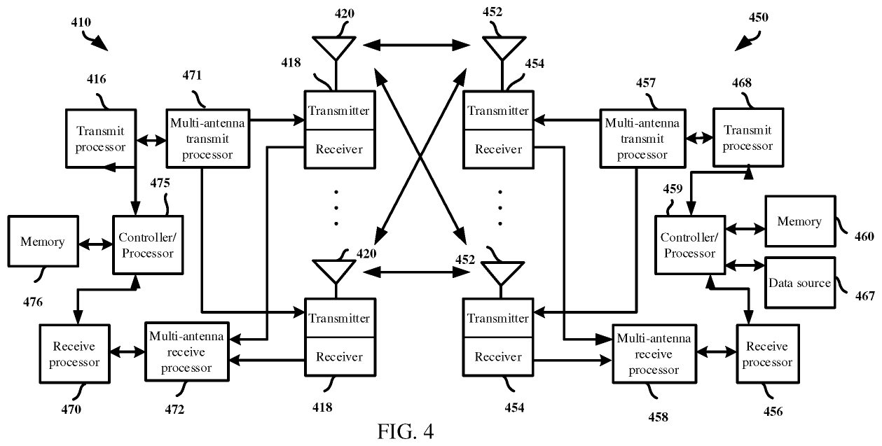

Embodiment 4 illustrates a schematic diagram of a first communication device and a second communication device according to this disclosure, as shown in FIG. 4. FIG. 4 is a block diagram of a first communication device 450 and a second communication device 410 communicating with each other in an access network.

The first communication device 450 includes a controller/processor 459, a memory 460, a data source 467, a transmit processor 468, a receive processor 456, a multi-antenna transmit processor 457, a multi-antenna receive processor 458, a transmitter/receiver 454, and an antenna 452.

The second communication device 410 includes a controller/processor 475, a memory 476, a receive processor 470, a transmit processor 416, a multi-antenna receive processor 472, a multi-antenna transmit processor 471, a transmitter/receiver 418, and an antenna 420.

During transmission from the second communication device 410 to the first communication device 450, at the second communication device 410, an upper layer data packet from a core network is provided to the controller/processor 475. The controller/processor 475 implements a function of an L2 layer. During transmission from the second communication device 410 to the first communication device 450, the controller/processor 475 provides header compression, encryption, packet segmentation and reordering, multiplexing between logical and transport channels, and allocation of radio resources of the first communication device 450 based on various priority measurements. The controller/processor 475 is further responsible for retransmission of a lost packet, and signaling to the first communication device 450. The transmit processor 416 and the multi-antenna transmit processor 471 implement various signal processing functions of an L1 layer (namely, a physical layer). The transmit processor 416 implements encoding and interleaving to facilitate forward error correction (FEC) at the second communication device 410, and mapping of signal clusters based on various modulation schemes (such as binary phase shift keying (BPSK), quadrature phase shift keying (QPSK), M-ary phase shift keying (M-PSK), and M-ary quadrature amplitude modulation (M-QAM)). The multi-antenna transmit processor 471 performs digital space precoding, including codebook-based precoding and non-codebook-based precoding, on a coded and modulated symbol, and beamforming processing, to generate one or more spatial streams. The transmit processor 416 then maps each spatial stream to a subcarrier, multiplexes the mapped spatial stream with a reference signal (for example, a pilot) in time domain and/or frequency domain, and then uses inverse fast Fourier transform (IFFT) to generate a physical channel that carries a time-domain multicarrier symbol stream. Subsequently, the multi-antenna transmit processor 471 performs an operation of analog precoding sending/beamforming on the time-domain multicarrier symbol stream. Each transmitter 418 converts a baseband multicarrier symbol stream provided by the multi-antenna transmit processor 471 into a radio frequency stream, and then provides the radio frequency stream for different antennas 420.

During transmission from the second communication device 410 to the first communication device 450, at the first communication device 450, each receiver 454 receives a signal through a corresponding antenna 452 of the receiver. Each receiver 454 recovers information modulated onto a radio frequency carrier, converts a radio frequency stream into a baseband multicarrier symbol stream, and provides the baseband multicarrier symbol stream for the receive processor 456. The receive processor 456 and the multi-antenna receive processor 458 implement various signal processing functions of the L1 layer. The multi-antenna receive processor 458 performs an operation of analog precoding receiving/beamforming on the baseband multicarrier symbol stream from the receiver 454. The receive processor 456 converts, from time domain to frequency domain via fast Fourier transform (FFT), the baseband multicarrier symbol stream obtained after the operation of analog precoding receiving/beamforming. In frequency domain, a physical-layer data signal and a reference signal are demultiplexed by the receive processor 456. The reference signal is used for channel estimation, and the data signal is recovered after multi-antenna detection performed by the multi-antenna receive processor 458, to obtain any spatial stream that uses the first communication device 450 as a destination. A symbol on each spatial stream is demodulated and recovered in the receive processor 456, and a soft decision is generated. The receive processor 456 then decodes and de-interleaves the soft decision to recover upper layer data and a control signal transmitted by the second communication device 410 on a physical channel. The upper layer data and the control signal are then provided for the controller/processor 459. The controller/processor 459 implements functions of the L2 layer. The controller/processor 459 may be correlated with the memory 460 that stores program code and data. The memory 460 may be referred to as a computer-readable medium. During transmission from the second communication device 410 to the first communication device 450, the controller/processor 459 provides demultiplexing between transport and logical channels, packet reassembly, decryption, header decompression, and control signal processing, to recover the upper layer data packet from the core network. The upper layer packet is then provided for all protocol layers above the L2 layer, or various control signals may be provided for an L3 for processing by the L3.

During transmission from the first communication device 450 to the second communication device 410, at the first communication device 450, an upper layer data packet is provided for the controller/processor 459 by using the data source 467. The data source 467 represents all protocol layers above the L2 layer. Similar to the sending function, at the second communication device 410, described during the transmission from the second communication device 410 to the first communication device 450, the controller/processor 459 implements header compression, encryption, packet segmentation and reordering, and multiplexing between logical and transport channels based on radio resource allocation, to implement an L2 layer function for a user plane and a control plane. The controller/processor 459 is further responsible for retransmission of a lost packet, and signaling to the second communication device 410. The transmit processor 468 performs modulation mapping and channel encoding processing, and the multi-antenna transmit processor 457 performs digital multi-antenna spatial precoding, including codebook-based precoding and non-codebook-based precoding, and beam forming processing. Then the transmit processor 468 modulates a generated spatial stream into a multicarrier/single-carrier symbol stream, and the multicarrier/single-carrier symbol stream is provided for different antennas 452 by using the transmitter 454 after undergoing an analog precoding/beamforming operation in the multi-antenna transmit processor 457. Each transmitter 454 first converts a baseband symbol stream provided by the multi-antenna transmit processor 457 into a radio frequency symbol stream, and then provides the radio frequency symbol stream for the antenna 452.

During transmission from the first communication device 450 to the second communication device 410, a function at the second communication device 410 is similar to the receiving function, at the first communication device 450, described during the transmission from the second communication device 410 to the first communication device 450. Each receiver 418 receives a radio frequency signal through a corresponding antenna 420 of the receiver, converts the received radio frequency signal into a baseband signal, and provides the baseband signal for the multi-antenna receive processor 472 and the receive processor 470. The receive processor 470 and the multi-antenna receive processor 472 jointly implement functions of the L1 layer. The controller/processor 475 implements functions of the L2 layer. The controller/processor 475 may be correlated with a memory 476 that stores program code and data. The memory 476 may be referred to as a computer-readable medium. During transmission from the first communication device 450 to the second communication device 410, the controller/processor 475 provides demultiplexing between transport and logical channels, packet reassembly, decryption, header decompression, and control signal processing, to recover an upper layer data packet from the first communication device 450. An upper layer data packet from the controller/processor 475 may be provided for a core network.

In an embodiment, the first communication device 450 includes at least one processor and at least one memory. The at least one memory includes computer program code, and the at least one memory and the computer program code are configured to be used with the at least one processor. The first communication device 450 at least: measures a reference signal using a plurality of spatial filtering parameters separately, and sends a first wireless signal. A first spatial filtering parameter is used for sending the first wireless signal. The first spatial filtering parameter is one of the plurality of spatial filtering parameters, and reception quality measured on a target path using the plurality of spatial filtering parameters is used for determining the first spatial filtering parameter.

In an embodiment, the first communication device 450 includes a memory storing a computer-readable instruction program. The computer-readable instruction program, when executed by at least one processor, generates actions, and the actions include: measuring a reference signal using a plurality of spatial filtering parameters separately, and sending a first wireless signal. A first spatial filtering parameter is used for sending the first wireless signal. The first spatial filtering parameter is one of the plurality of spatial filtering parameters, and reception quality measured on a target path using the plurality of spatial filtering parameters is used for determining the first spatial filtering parameter.

In an embodiment, the second communication device 410 includes at least one processor and at least one memory, the at least one memory including computer program code, and the at least one memory and the computer program code are configured to be used with the at least one processor. The second communication device 410 at least receives a first wireless signal. A first spatial filtering parameter is used by a sender of the first wireless signal for sending the first wireless signal. The sender of the first wireless signal measures a reference signal using a plurality of spatial filtering parameters separately. The first spatial filtering parameter is one of the plurality of spatial filtering parameters, and reception quality measured on a target path using the plurality of spatial filtering parameters is used by the sender of the first wireless signal for determining the first spatial filtering parameter.

In an embodiment, the second communication device 410 includes a memory storing a computer-readable instruction program. The computer-readable instruction program, when executed by at least one processor, generates an action, and the action includes: receiving a first wireless signal. A first spatial filtering parameter is used by a sender of the first wireless signal for sending the first wireless signal. The sender of the first wireless signal measures a reference signal using a plurality of spatial filtering parameters separately. The first spatial filtering parameter is one of the plurality of spatial filtering parameters, and reception quality measured on a target path using the plurality of spatial filtering parameters is used by the sender of the first wireless signal for determining the first spatial filtering parameter.

In an embodiment, at least one of the antenna 452, the receiver 454, the receive processor 456, and the controller/processor 459 is used to receive a reference signal.

In an embodiment, at least one of the antenna 420, the transmitter 418, the transmit processor 416, and the controller/processor 475 is used to send a reference signal.

In an embodiment, at least one of the antenna 452, the transmitter 454, the transmit processor 468, and the controller/processor 459 is used to send a first wireless signal.

In an embodiment, at least one of the antenna 420, the receiver 418, the receive processor 470, and the controller/processor 475 is used to receive a first wireless signal.

In an embodiment, at least one of the antenna 452, the transmitter 454, the transmit processor 468, and the controller/processor 459 is used to send first measurement information.

In an embodiment, at least one of the antenna 420, the receiver 418, the receive processor 470, and the controller/processor 475 is used to receive first measurement information.

In an embodiment, the first communication device 450 corresponds to a first node in this disclosure.

In an embodiment, the second communication device 410 corresponds to a second node in this disclosure.

In an embodiment, the first communication device 450 is a user equipment.

In an embodiment, the first communication device 450 is a base station device.

In an embodiment, the first communication device 450 is a relay device.

In an embodiment, the first communication device 450 is a target device.

In an embodiment, the second communication device 410 is a user equipment.

In an embodiment, the second communication device 410 is a base station device.

In an embodiment, the second communication device 410 is a location server.

In an embodiment, the second communication device 410 is a relay device.

### Embodiment 5

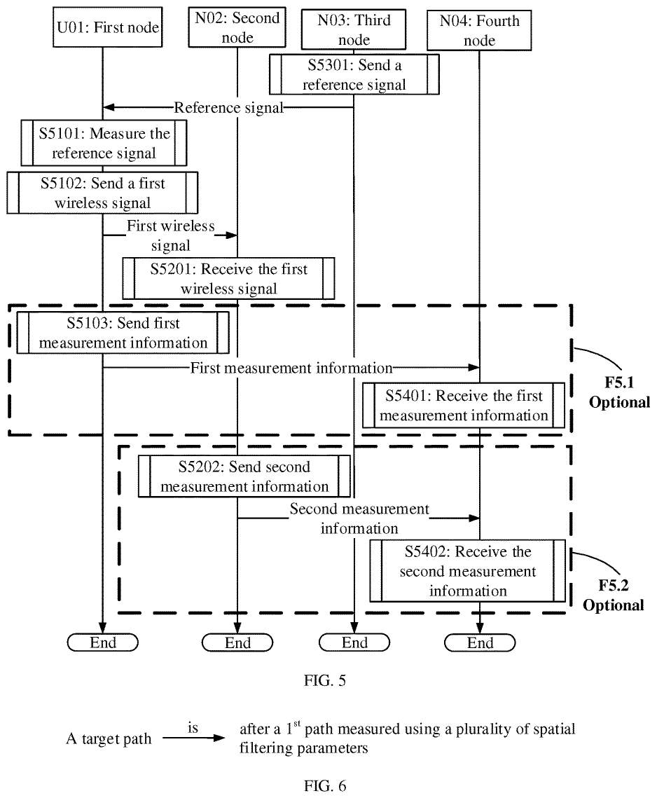

Embodiment 5 illustrates a flowchart of transmission of a wireless signal according to an embodiment of this disclosure, as shown in FIG. 5. It should be particularly noted that an order in this example does not limit an order of signal transmission and an order of implementation in this disclosure.

For a first node U01: In step S5101, measure a reference signal using a plurality of spatial filtering parameters separately; in step S5102, send a first wireless signal, where a first spatial filtering parameter is used for sending the first wireless signal; and in step S5103, send first measurement information.

For a second node N02: In step S5201, receive the first wireless signal; in step S5202, send second measurement information, where the second measurement information includes a difference between a reception timing of a reception frame and a transmission timing of a transmission frame, and the reception frame includes the first wireless signal.

For a third node N03: In step S5301, send the reference signal.

For a fourth node N04: In step S5401, receive the first measurement information; and in step S5402, receive the second measurement information.

In Embodiment 5, the first spatial filtering parameter is one of the plurality of spatial filtering parameters, and reception quality measured on a target path using the plurality of spatial filtering parameters is used for determining the first spatial filtering parameter; the first measurement information includes a difference between a reception timing of the reference signal and a transmission timing of the first wireless signal.

In an embodiment, the first node U01 and the second node N02 are connected in a wireless manner.

In an embodiment, the first node U01 and the second node N02 are connected through a Uu interface.

In an embodiment, the first node U01 and the second node N02 are connected through an IAB interface.

In an embodiment, the first node U01 and the second node N02 are connected through a PC5 interface.

In an embodiment, the first node U01 and the third node N03 are connected in a wireless manner.

In an embodiment, the first node U01 and the third node N03 are connected through a Uu interface.

In an embodiment, the first node U01 and the third node N03 are connected through an IAB interface.

In an embodiment, the first node U01 and the third node N03 are connected through a PC5 interface.

In an embodiment, the first node U01 and the fourth node N04 are connected in a wireless manner.

In an embodiment, the first node U01 and the fourth node N04 are connected in a wired manner.

In an embodiment, the first node U01 and the fourth node N04 are connected through a Uu interface.

In an embodiment, the first node U01 and the fourth node N04 are connected through an IAB interface.

In an embodiment, the first node U01 and the fourth node N04 are connected through a PC5 interface.

In an embodiment, the first node is a target device.

In an embodiment, the first node is a UE.

In an embodiment, the first node is a RAN node.

In an embodiment, the second node is a RAN node.

In an embodiment, the second node is part of a RAN node.

In an embodiment, the second node is a reception point, and a definition of the RP refers to 3GPP TS 38.305.

In an embodiment, the second node is an SRS-only RP, and a definition of the SRS-only RP refers to 3GPP TS 38.305.

In an embodiment, the second node is a sensing-only RP.

In an embodiment, the second node is an IRS-only RP.

In an embodiment, the second node is a transmission reception point (TRP), and the definition of the TRP refers to 3GPP TS 38.305.

In an embodiment, the third node and the second node are the same.

In an embodiment, the third node and the second node are different.

In an embodiment, the third node is a transmission point, and a definition of the TP refers to 3GPP TS 38.305.

In an embodiment, the third node is a PRS-only TP, and a definition of the PRS-only TP refers to 3GPP TS 38.305.

In an embodiment, the third node N03 sends the reference signal using the plurality of spatial filtering parameters separately.

In an embodiment, the third node N03 sends the reference signal using only one spatial filtering parameter.

In an embodiment, the fourth node and the second node are the same.

In an embodiment, the fourth node and the second node are different.

In an embodiment, the fourth node is a UE.

In an embodiment, the fourth node is a RAN node.

In an embodiment, the fourth node is a location server.

In an embodiment, the first node is a RAN node; and the second node, the third node, and the fourth node are a UE.

In an embodiment, the first node is UE; and the second node, the third node, and the fourth node are a RAN node.

In an embodiment, the first node is a target device; and the second node and the third node are a RAN node, and the fourth node is a location server.

In an embodiment, the first node is a target device; the second node and the third node each are a RAN node, and the fourth node is a location server.

In an embodiment, a dashed box F5.1 is optional.

In an embodiment, the dashed box F5.1 exists.

In an embodiment, the dashed box F5.1 does not exist.

In an embodiment, a dashed box F5.2 is optional.

In an embodiment, the dashed box F5.2 exists.

In a sub-embodiment of the foregoing embodiment, the first node is a target device; and the second node and the third node each are a RAN node, and the fourth node is a location server.

In a sub-embodiment of the foregoing embodiment, the difference that is between the reception timing of the reception frame and the transmission timing of the transmission frame and that is included by the second measurement information is gNB Rx−Tx time difference.

In a sub-embodiment of the foregoing embodiment, a reception timing of the transmission frame is T_{gNB-TX}.

In a sub-embodiment of the foregoing embodiment, the transmission frame is closest in time to the reception frame.

In a sub-embodiment of the foregoing embodiment, the reception timing of the reception frame is T_{gNB-RX}.

In a sub-embodiment of the foregoing embodiment, the reception frame includes at least one path of the first wireless signal.

In a sub-embodiment of the foregoing embodiment, the reception frame includes a first path of the first wireless signal.

In a sub-embodiment of the foregoing embodiment, the reception frame includes a path, with strongest reception quality, of the first wireless signal.

In a sub-embodiment of the foregoing embodiment, the reception frame includes a path, reciprocal to the target path, of the first wireless signal.

In a sub-embodiment of the foregoing embodiment, the reception frame is an uplink frame, and the transmission frame is a downlink frame.

In a sub-embodiment of the foregoing embodiment, the reception frame is a downlink frame, and the transmission frame is an uplink frame.

In a sub-embodiment of the foregoing embodiment, the reception frame is a sidelink frame, and the transmission frame is a sidelink frame.

In a sub-embodiment of the foregoing embodiment, the second measurement information includes an SRPP of the first wireless signal.

In a sub-embodiment of the foregoing embodiment, the second measurement information includes RSRPP of the first path of the first wireless signal.

In a sub-embodiment of the foregoing embodiment, the second measurement information includes RSRPP, in a path reciprocal to the target path, of the first wireless signal.

In an embodiment, the dashed box F5.2 does not exist.

In an embodiment, a recipient of the first measurement information is a location server.

In an embodiment, the recipient of the first measurement information is a RAN node.

In an embodiment, the first measurement information is a measurement report.

In an embodiment, the first measurement information is generated at an RRC sublayer.

In an embodiment, the foregoing method reduces protocol impact.

In an embodiment, the foregoing method can support more flexible reporting.

In an embodiment, the foregoing method is more reliable.

In an embodiment, the foregoing method saves a resource of a physical layer control channel.

In an embodiment, the first measurement information is an RRC message.

In an embodiment, the first measurement information includes at least one RRC Information Element (information element, IE).

In an embodiment, the first measurement information includes at least one RRC field.

In an embodiment, the first measurement information is transmitted through a Physical uplink shared channel (physical uplink shared channel, PUSCH).

In an embodiment, the first measurement information belongs to a Dedicated Control Channel (dedicated control channel, DCCH) message.

In an embodiment, the first measurement information is transmitted through a Signaling Radio Bearer 1 (signaling radio bearer 1, SRB1).

In an embodiment, the first measurement information is transmitted through a Signaling Radio Bearer 3 (signaling radio bearer 3, SRB3).

In an embodiment, the first measurement information belongs to a MeasurementReport message.

In an embodiment, the first measurement information belongs to an RRC IE, and the RRC IE is for ISAC.

In an embodiment, the first measurement information belongs to an RRC IE, and the RRC IE is for positioning.

In an embodiment, the first measurement information belongs to an RRC IE, and the RRC IE is for sensing.

In an embodiment, the first measurement information belongs to a UEAssistanceInformation message.

In an embodiment, the first measurement information is physical layer signaling.

In an embodiment, the foregoing method is beneficial for reducing a delay.

In an embodiment, the foregoing method is beneficial for improving data reliability.

In an embodiment, the first measurement information is uplink control information (UCI).

In an embodiment, the first measurement information is transmitted through a physical uplink control channel (PUCCH).

In an embodiment, the first measurement information is transmitted through a PUSCH.

In an embodiment, the first measurement information is a medium access control control element (MAC CE).

In an embodiment, the foregoing method reduces a delay while reducing protocol impact.

In an embodiment, the foregoing method reduces a delay while saving a physical layer control channel resource.

In an embodiment, the first measurement information is generated at an LPP layer.

In an embodiment, the first measurement information is an LPP message.

In an embodiment, the first measurement information is transmitted through an SRB2.

In an embodiment, the first measurement information belongs to an RRC container.

In an embodiment, the first measurement information belongs to a ULInformationTransfer message.

In a sub-embodiment of the foregoing embodiment, an LPP PDU includes the first measurement information.

In a sub-embodiment of the foregoing embodiment, an LPP PDU in a payload container of a UL NAS Transport message includes the first measurement information.

In a sub-embodiment of the foregoing embodiment, an RRC UL Information Transfer message includes the first measurement information.

In an embodiment, the first measurement information terminates at the fourth node.

In an embodiment, the fourth node receives an RRC message, and the RRC message includes the first measurement information.

In an embodiment, the fourth node receives an LPP PDU, and the LPP PDU includes the first measurement information.

In an embodiment, the first node sends an RRC message, where the first measurement information is generated at an RRC sublayer, and the RRC message includes the first measurement information; and the fourth node receives the RRC message.

In an embodiment, the first node sends an RRC message, where the first measurement information is generated at an LPP layer, the RRC message includes an LPP PDU, and the LPP PDU includes the first measurement information; an NG-RAN node receives the RRC message and forwards the LPP PDU to an AMF through a UL NAS Transport message; and the AMF receives the UL NAS Transport message and forwards the LPP PDU to the fourth node through Namf_Communication_N1MessageNotify.

In an embodiment, the difference between the reception timing of the reference signal and the transmission timing of the first wireless signal is an Rx−Tx time difference.

In an embodiment, the difference between the reception timing of the reference signal and the transmission timing of the first wireless signal is TUE-RX-TUE-TX.

In an embodiment, the reception timing of the reference signal refers to: a reception timing of only one path of the reference signal.

In a sub-embodiment of the foregoing embodiment, the only one path refers to: a last path.

In a sub-embodiment of the foregoing embodiment, the foregoing method is beneficial for determining delay information of the last path.

In a sub-embodiment of the foregoing embodiment, the only one path refers to: the first path.

In a sub-embodiment of the foregoing embodiment, the foregoing method is beneficial for determining delay information of the first path.

In a sub-embodiment of the foregoing embodiment, the only one path refers to: the target path.

In a sub-embodiment of the foregoing embodiment, the foregoing method is beneficial for determining delay information of the target path.

In an embodiment, the reception timing of the reference signal refers to: a reception timing of at least one path of the reference signal.

In a sub-embodiment of the foregoing embodiment, the first measurement information includes a difference between the reception timing of the at least one path of the reference signal and the transmission timing of the first wireless signal.

In an embodiment, the first measurement information includes a difference between reception timings of a plurality of paths of the reference signal and the transmission timing of the first wireless signal.

In a sub-embodiment of the foregoing embodiment, the plurality of paths of the reference signal refer to: all paths of the reference signal.

In a sub-embodiment of the foregoing embodiment, the plurality of paths of the reference signal refer to: the first path and at most K1 paths.

In a sub-embodiment of the foregoing embodiment, the plurality of paths of the reference signal refer to: paths in first candidate path set, where reception quality measured on the first candidate path set using the plurality of spatial filtering parameters is used for determining the first spatial filtering parameter, the first candidate path set includes a plurality of paths, and the target path is one of the plurality of paths.

In an embodiment, the first measurement information includes a difference between the reception timing of the only one path of the reference signal and the transmission timing of the first wireless signal.

In an embodiment, a reception timing of one path refers to reception time of the one path.

In an embodiment, the reception timing of one path refers to a timing of a given frame of the one path.

In a sub-embodiment of the foregoing embodiment, the given frame is of a downlink.

In a sub-embodiment of the foregoing embodiment, the given frame is of a sidelink.

In a sub-embodiment of the foregoing embodiment, the given frame is of an IAB link.

In a sub-embodiment of the foregoing embodiment, the reference signal is used for determining a start of the given frame.

In a sub-embodiment of the foregoing embodiment, the plurality of paths of the reference signal are used for determining the start of the given frame.

In a sub-embodiment of the foregoing embodiment, the first path is used for determining the start of the given frame.

In a sub-embodiment of the foregoing embodiment, the target path is used for determining the start of the given frame.

In a sub-embodiment of the foregoing embodiment, the timing of the given frame of the one path refers to a reception timing of a given frame to which the one path belongs.

In a sub-embodiment of the foregoing embodiment, the timing of the given frame of the one path refers to a reception timing of a given frame defined by the one path.

In a sub-embodiment of the foregoing embodiment, the timing of the given frame of the one path refers to a reception timing of a given frame that receives the one path.

In a sub-embodiment of the foregoing embodiment, the timing of the given frame of the one path refers to a timing of the one path in a given frame.

In an embodiment, the given frame is an NR frame.

In an embodiment, the given frame is a 6G system frame.

In an embodiment, the given frame is an ISAC system frame.

In an embodiment, the given frame refers to a superframe.

In an embodiment, the given frame refers to a radio frame.

In an embodiment, the given frame refers to a system frame.

In an embodiment, the given frame refers to a half-frame.

In an embodiment, the given frame refers to a subframe.

In an embodiment, the given frame refers to a slot.

In an embodiment, the given frame refers to a symbol.

In an embodiment, the given frame includes a plurality of slots.

In an embodiment, the given frame includes a plurality of symbols.

Typically, the reception timing of the reference signal refers to: a reception timing of a downlink subframe defined by the first path.

Typically, the reception timing of the reference signal refers to: a reception timing of a downlink subframe defined by the target path.

In an embodiment, after measuring the reference signal using the plurality of spatial filtering parameters separately, only the first wireless signal is sent.

In an embodiment, after measuring the reference signal using the plurality of spatial filtering parameters separately, Q1 wireless signals are sent. Q2 spatial filtering parameters are used for sending the Q1 wireless signals. The Q2 spatial filtering parameters are among the plurality of spatial filtering parameters, and reception quality measured on Q3 paths using the Q2 spatial filtering parameters separately is used for determining Q1 spatial filtering parameters. The first wireless signal is one of the Q1 wireless signals, the first spatial filtering parameter is one of the Q2 spatial filtering parameters, and the target path is one of the Q3 paths.

In a sub-embodiment of the foregoing embodiment, the Q1 wireless signals are for Q1 targets.

In a sub-embodiment of the foregoing embodiment, any two wireless signals in the Q1 wireless signals use different spatial filtering parameters, and Q2 is Q1.

In a sub-embodiment of the foregoing embodiment, there are two wireless signals in the Q1 wireless signals, the two wireless signals use a same spatial filtering parameter, and Q2 is less than Q1.

In a sub-embodiment of the foregoing embodiment, Q1, Q2, and Q3 are equal.

In a sub-embodiment of the foregoing embodiment, Q1 is an integer greater than 1.

In a sub-embodiment of the foregoing embodiment, Q1 is 1.

In a sub-embodiment of the foregoing embodiment, Q1 is fixed.

In a sub-embodiment of the foregoing embodiment, Q1 depends on configuration.

In a sub-embodiment of the foregoing embodiment, Q1 is an integer not greater than Q2.

In a sub-embodiment of the foregoing embodiment, Q1 is an integer not greater than Q3.

In a sub-embodiment of the foregoing embodiment, Q2 is Q1.

In a sub-embodiment of the foregoing embodiment, Q2 is an integer not greater than Q3.

In a sub-embodiment of the foregoing embodiment, Q2 is an integer not greater than Q1.

In an embodiment, the first measurement information includes differences between the reception timing of the reference signal and transmission timings of the Q1 wireless signals separately.

In an embodiment, the first measurement information includes a difference between a reception timing of the target path and a reception timing of the first path.

In a sub-embodiment of the foregoing embodiment, the first measurement information includes a difference between a reception timing of each path in the first candidate path set and the reception timing of the first path.

In a sub-embodiment of the foregoing embodiment, the first measurement information includes a difference between a reception timing of each path in the Q3 paths and the reception timing of the first path.

In an embodiment, the first measurement information does not indicate reception quality of the target path.

In an embodiment, the first measurement information indicates the reception quality of the target path.

In a sub-embodiment of the foregoing embodiment, the first measurement information includes RSRP of the target path.

In a sub-embodiment of the foregoing embodiment, the first measurement information includes RSRPP of the target path.

In a sub-embodiment of the foregoing embodiment, the first measurement information includes an SINR of the target path.

In a sub-embodiment of the foregoing embodiment, the first measurement information includes an SNR of the target path.

In a sub-embodiment of the foregoing embodiment, the first measurement information includes an MSE of the target path.

In an embodiment, the first measurement information does not indicate sending power of the first wireless signal.

In an embodiment, the first measurement information indicates the sending power of the first wireless signal.

In a sub-embodiment of the foregoing embodiment, the first measurement information includes a parameter of the sending power of the first wireless signal.

In a sub-embodiment of the foregoing embodiment, the first measurement information includes an index of the sending power of the first wireless signal.

In an embodiment, the first measurement information does not indicate that the first wireless signal is repeated.

In an embodiment, the first measurement information indicates that the first wireless signal is repeated.

In a sub-embodiment of the foregoing embodiment, the first measurement information indicates a quantity of repetitions of the first wireless signal.

### Embodiment 6

Embodiment 6 illustrates a schematic diagram of a target path after a first path measured using a plurality of spatial filtering parameters according to an embodiment of this disclosure, as shown in FIG. 6.

In Embodiment 6, the target path is after the first path measured using the plurality of spatial filtering parameters.

In an embodiment, a spatial filtering parameter used for measuring the target path is not a first spatial filtering parameter.

In an embodiment, the spatial filtering parameter used for measuring the target path is the first spatial filtering parameter.

In an embodiment, reception quality measured on the first path using the plurality of spatial filtering parameters is used for determining the first spatial filtering parameter.

In an embodiment, the target path is not the first path.

In an embodiment, a time interval between the target path and the first path satisfies a threshold.

In an embodiment, the threshold is configurable.

In an embodiment, the threshold is pre-configured.

In an embodiment, the threshold is configured at an LPP layer.

In an embodiment, the threshold is configured at an RRC sublayer.

In an embodiment, the time interval between the target path and the first path refers to a delay between the target path and the first path.

In an embodiment, the time interval between the target path and the first path refers to a time interval from measurement of the first path to measurement of the target path.

In an embodiment, the time interval between the target path and the first path refers to a time interval between a reception start moment of the target path and a reception start moment of the first path.

In an embodiment, the time interval between the target path and the first path refers to a time interval between a reception end moment of the target path and a reception end moment of the first path.

### Embodiment 7

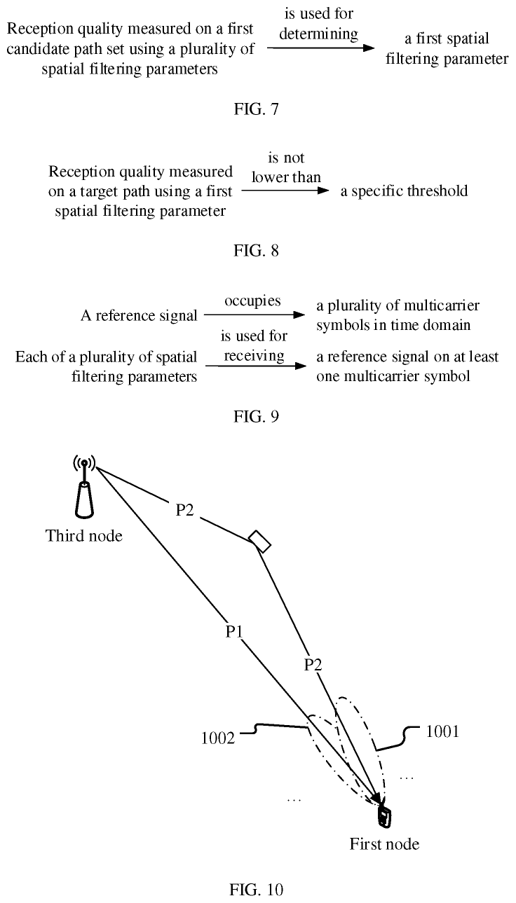

Embodiment 7 illustrates a schematic diagram in which reception quality measured on a first candidate path set using a plurality of spatial filtering parameters is used for determining a first spatial filtering parameter according to an embodiment of this disclosure, as shown in FIG. 7.

In Embodiment 7, the reception quality measured on the first candidate path set using the plurality of spatial filtering parameters is used for determining the first spatial filtering parameter, the first candidate path set includes a plurality of paths, and the target path is one of the plurality of paths.

In an embodiment, the first candidate path set includes at least one path.

In an embodiment, the first candidate path set includes a first path.

In an embodiment, the first candidate path set does not include the first path.

In an embodiment, the paths in the first candidate path set are correlated.

In an embodiment, a meaning that the paths in the first candidate path set are correlated includes: a delay between any two paths on the first candidate path set is less than a given delay threshold.

In an embodiment, the meaning that the paths in the first candidate path set are correlated includes: a difference in reception quality between any two paths on the first candidate path set is less than a given reception quality threshold.

In an embodiment, the meaning that the paths in the first candidate path set are correlated includes: a delay between any two paths on the first candidate path set is less than a given delay threshold, and a difference in reception quality between any two paths on the first candidate path set is less than a given reception quality threshold.

In an embodiment, the first candidate path set is used for determining a same target.

In an embodiment, the paths in the first candidate path set all pass through a same target.

In an embodiment, the paths in the first candidate path set are reflected by the target.

In an embodiment, a first node determines that the first candidate path set is for a same target based on the correlation of the paths in the first candidate path set.

In an embodiment, the target is passive.

In an embodiment, the target reflects a reference signal.

In an embodiment, a type of the target is pre-configured.

In an embodiment, the type of the target is pre-defined.

In an embodiment, a size of the target is pre-configured.

In an embodiment, the size of the target is pre-defined.

In an embodiment, the target is a vehicle.

In an embodiment, the target is an unmanned aerial vehicle (UAV).

In an embodiment, the target is a person.

In an embodiment, the target is an automated guided vehicle.

In an embodiment, the target is a dangerous object.

In an embodiment, the target path is after a first path measured using the plurality of spatial filtering parameters, reception quality measured on the first candidate path set using the plurality of spatial filtering parameters is used for determining the first spatial filtering parameter, the first candidate path set includes a plurality of paths, and the target path is one of the plurality of paths.

In an embodiment, the target path is any one of the plurality of paths.

In an embodiment, the target path is an earliest path in the plurality of paths.

In an embodiment, the earliest path in the plurality of paths refers to: an earliest detected path in the plurality of paths.

In an embodiment, the earliest path in the plurality of paths refers to: a first path detected in time in the plurality of paths.

### Embodiment 8

Embodiment 8 illustrates a schematic diagram in which reception quality measured on a target path using a first spatial filtering parameter is not lower than a specific threshold according to an embodiment of this disclosure, as shown in FIG. 8.

In Embodiment 8, the reception quality measured on the target path using the first spatial filtering parameter is not lower than the specific threshold.

In an embodiment, a meaning that the reception quality measured on the target path using the first spatial filtering parameter is not lower than the specific threshold includes: reception quality measured only on the target path using a plurality of spatial filtering parameters is not lower than the specific threshold.

In an embodiment, the meaning that the reception quality measured on the target path using the first spatial filtering parameter is not lower than the specific threshold includes: reception quality measured only on the target path other than the first path using the plurality of spatial filtering parameters is not lower than the specific threshold.

In an embodiment, the meaning that the reception quality measured on the target path using the first spatial filtering parameter is not lower than the specific threshold includes: reception quality measured on a plurality of paths using the plurality of spatial filtering parameters is not lower than the specific threshold, and the target path is one of the plurality of paths.

In a sub-embodiment of the foregoing embodiment, the target path is any one of the plurality of paths.

In a sub-embodiment of the foregoing embodiment, the target path is a path with highest reception quality in the plurality of paths.

In an embodiment, the first spatial filtering parameter is determined before a first wireless signal is sent.

In an embodiment, the first spatial filtering parameter is determined after a reference signal is measured using the plurality of spatial filtering parameters separately.

In an embodiment, the first spatial filtering parameter is determined in response to measuring the reference signal using the plurality of spatial filtering parameters separately.

In an embodiment, determining the first spatial filtering parameter depends on the reception quality measured on the target path using the first spatial filtering parameter being not lower than the specific threshold.

In an embodiment, the reception quality measured on the target path using the plurality of spatial filtering parameters being not lower than the specific threshold is used for determining the first spatial filtering parameter.

In an embodiment, the first spatial filtering parameter is determined when the reception quality measured on the target path using at least the first spatial filtering parameter is not lower than the specific threshold.

In an embodiment, the first spatial filtering parameter is determined only when the reception quality measured on the target path using the first spatial filtering parameter is not lower than the specific threshold.

In an embodiment, the reception quality measured on the target path using the plurality of spatial filtering parameters being not lower than the specific threshold triggers determining the first spatial filtering parameter.

In an embodiment, the reception quality measured on the target path using the plurality of spatial filtering parameters being not lower than the specific threshold triggers sending the first wireless signal.

In an embodiment, the specific threshold is configurable.

In an embodiment, the specific threshold is pre-configured.

In an embodiment, the specific threshold is configured by a second node.

In an embodiment, the specific threshold is configured by a fourth node.

In an embodiment, the specific threshold is configured at an LPP layer.

In an embodiment, the specific threshold is configured at an RRC sublayer.

In an embodiment, the “not lower than” is “higher than”.

In an embodiment, the “not lower than” is “higher than” or “equal to”.

In an embodiment, the specific threshold is dedicated to a specific type of target.

In an embodiment, this is beneficial for detection and/or tracking of different types of targets.

In an embodiment, the reception quality measured on the target path using the first spatial filtering parameter is not lower than the specific threshold, and the reception quality measured on the target path using the first spatial filtering parameter is not higher than a given threshold.

In an embodiment, the given threshold is configured by the second node.

In an embodiment, the given threshold is configured by the fourth node.

In an embodiment, the given threshold is configured at the LPP layer.

In an embodiment, the given threshold is configured at the RRC sublayer.

In an embodiment, the “not higher than” is “lower than”.

In an embodiment, the “not higher than” is “lower than” or “equal to”.

In an embodiment, the specific threshold and the given threshold are dedicated to a specific type of target.

In an embodiment, the foregoing method avoids a sensing error.

In an embodiment, reception quality measured on a first candidate path set using the first spatial filtering parameter is not lower than the specific threshold, the reception quality measured on the first candidate path set using the plurality of spatial filtering parameters is used for determining the first spatial filtering parameter, the first candidate path set includes a plurality of paths, and the target path is one of the plurality of paths.

In a sub-embodiment of the foregoing embodiment, the reception quality measured on the first candidate path set using the first spatial filtering parameter being not lower than the specific threshold includes the reception quality measured on the target path using the first spatial filtering parameter being not lower than the specific threshold.

In a sub-embodiment of the foregoing embodiment, the reception quality measured on the first candidate path set refers to: the reception quality measured on any path in the first candidate path set.

In a sub-embodiment of the foregoing embodiment, the reception quality measured on the first candidate path set refers to: an average value of the reception quality measured on all paths in the first candidate path set.

In a sub-embodiment of the foregoing embodiment, the reception quality measured on the first candidate path set refers to: a weighted average value of the reception quality measured on all paths in the first candidate path set.

In a sub-embodiment of the foregoing embodiment, the reception quality measured on the first candidate path set refers to: the reception quality measured on each path in the first candidate path set.

### Embodiment 9

Embodiment 9 illustrates a schematic diagram in which a reference signal occupies a plurality of multicarrier symbols in time domain according to an embodiment of this disclosure, as shown in FIG. 9.

In Embodiment 9, the reference signal occupies the plurality of multicarrier symbols in time domain, each of the plurality of spatial filtering parameters is used for receiving the reference signal on at least one multicarrier symbol.

In an embodiment, a meaning that the reference signal occupies the plurality of multicarrier symbols in time domain includes: a first node assumes that the reference signal is sent on the plurality of multicarrier symbols.

In an embodiment, the meaning that the reference signal occupies the plurality of multicarrier symbols in time domain includes: a second node sends the reference signal on the plurality of multicarrier symbols.

In an embodiment, the meaning that the reference signal occupies the plurality of multicarrier symbols in time domain includes: the plurality of multicarrier symbols are configured for the reference signal.

In an embodiment, the meaning that the reference signal occupies the plurality of multicarrier symbols in time domain includes: the plurality of multicarrier symbols carry the reference signal.

In an embodiment, the meaning that the reference signal occupies the plurality of multicarrier symbols in time domain includes: a reception occasion of the reference signal occupies the plurality of multicarrier symbols in time domain.

In an embodiment, the meaning that the reference signal occupies the plurality of multicarrier symbols in time domain includes: each period of the reference signal in time domain occupies the plurality of multicarrier symbols.

In an embodiment, the multicarrier symbols are used for an NR system.

In an embodiment, the multicarrier symbols are used for a 6G system.

In an embodiment, the multicarrier symbols are used for a positioning system.

In an embodiment, the multicarrier symbols are used for a sensing system.

In an embodiment, the multicarrier symbols are used for an ISAC system.

In an embodiment, the multicarrier symbols are FMCW symbols.

In an embodiment, the multicarrier symbols are OTFS symbols.

In an embodiment, the multicarrier symbols are OFDM symbols.

In an embodiment, the multicarrier symbols are CP-OFDM symbols.

In an embodiment, the multicarrier symbols are DFT-S-OFDM symbols.

In an embodiment, the multicarrier symbols are OFDMA symbols.

In an embodiment, the plurality of multicarrier symbols belong to a same frame.

In an embodiment, the plurality of multicarrier symbols belong to a same half-frame.

In an embodiment, the plurality of multicarrier symbols belong to a same subframe.

In an embodiment, an index of a first multicarrier symbol in the plurality of multicarrier symbols is pre-configured.

In an embodiment, the index of the first multicarrier symbol in the plurality of multicarrier symbols depends on a subcarrier spacing.

In an embodiment, the reference signal occupies consecutive multicarrier symbols in time domain.

In an embodiment, the reference signal occupies non-consecutive multicarrier symbols in time domain.

In an embodiment, a quantity of multicarrier symbols occupied by the reference signal is configurable.

In an embodiment, the quantity of multicarrier symbols occupied by the reference signal is pre-configured.

In an embodiment, the quantity of multicarrier symbols occupied by the reference signal depends on the subcarrier spacing.

In an embodiment, a quantity of the at least one multicarrier symbol does not exceed the quantity of multicarrier symbols occupied by the reference signal in time domain.

In an embodiment, the quantity of the at least one multicarrier symbol is less than the quantity of multicarrier symbols occupied by the reference signal in time domain.

In an embodiment, the reference signal is repeated on the plurality of multicarrier symbols.

In a sub-embodiment of the foregoing embodiment, a quantity of times the reference signal is repeated on the plurality of multicarrier symbols is fixed.

In a sub-embodiment of the foregoing embodiment, the quantity of times the reference signal is repeated on the plurality of multicarrier symbols is pre-configured.

In a sub-embodiment of the foregoing embodiment, the quantity of times the reference signal is repeated on the plurality of multicarrier symbols is configured at an LPP layer.

In a sub-embodiment of the foregoing embodiment, the quantity of times the reference signal is repeated on the plurality of multicarrier symbols is configured at an RRC sublayer.

In an embodiment, each of the plurality of spatial filtering parameters is used for receiving the reference signal on the plurality of multicarrier symbols.

In a sub-embodiment of the foregoing embodiment, each of the plurality of spatial filtering parameters is used for receiving the reference signal on each of the plurality of multicarrier symbols.

In a sub-embodiment of the foregoing embodiment, the foregoing method is beneficial for detecting a target in a timely manner.

In a sub-embodiment of the foregoing embodiment, the foregoing method avoids missed detection.

In an embodiment, each of the plurality of spatial filtering parameters is used for receiving the reference signal on only one multicarrier symbol.

In a sub-embodiment of the foregoing embodiment, the foregoing method is beneficial for energy saving.

In a sub-embodiment of the foregoing embodiment, the foregoing method is beneficial for implementation.

In a sub-embodiment of the foregoing embodiment, the foregoing method reduces impact on the first node.

In a sub-embodiment of the foregoing embodiment, the foregoing method reduces interference.

In a sub-embodiment of the foregoing embodiment, the reference signal is received using the plurality of spatial filtering parameters in a beam sweeping manner.

In an embodiment, each of the plurality of spatial filtering parameters is used for receiving the reference signal on more than one multicarrier symbol.

In an embodiment, each of the plurality of spatial filtering parameters is used for receiving the reference signal on one or more multicarrier symbols.

In an embodiment, each of the plurality of spatial filtering parameters is used for receiving the reference signal on M1 multicarrier symbols, M1 is configurable, and M1 is a positive integer.

In an embodiment, on each of the plurality of multicarrier symbols, only one of the plurality of spatial filtering parameters is used.

In an embodiment, on each of the plurality of multicarrier symbols, more than one of the plurality of spatial filtering parameters are used.

In an embodiment, on each of the plurality of multicarrier symbols, N1 spatial filtering parameters in the plurality of spatial filtering parameters are used, N1 is configurable, and N1 is a positive integer.

### Embodiment 10

Embodiment 10 illustrates a schematic diagram of transmission of a reference signal according to an embodiment of this disclosure, as shown in FIG. 10. In FIG. 10, a third node sends the reference signal, and a first node receives the reference signal, dashed ellipses 1001 and 1002 correspond to two different spatial filtering parameters respectively, P1 and P2 each are a path of the reference signal, and a solid box represents a target.

In Embodiment 10, the reference signal is measured using at least a spatial filtering parameter 1001 and a spatial filtering parameter 1002 separately, P1 is a first path of the reference signal measured using the spatial filtering parameter 1002, P2 is a target path of the reference signal measured using the spatial filtering parameter 1001.

In an embodiment, this embodiment does not limit a quantity of spatial filtering parameters used for measuring the reference signal.

In an embodiment, this embodiment does not limit a quantity of paths of the measured reference signal.

In an embodiment, this embodiment does not limit a quantity of targets that the reference signal passes through.

### Embodiment 11

Embodiment 11 illustrates a schematic diagram of a relation between a spatial filtering parameter and a multicarrier symbol occupied by a reference signal station according to an embodiment of this disclosure, as shown in FIG. 11. In FIG. 11, a thick solid box 1100 represents a frame, a slash-filled box 1103 and a slash-filled box 1104 correspond to two different time domain resources for receiving the reference signal respectively, dashed ellipses 1101 and 1102 correspond to two different spatial filtering parameters respectively, the slash-filled box 1103 represents a time domain resource for receiving the reference signal using the spatial filtering parameter 1101, and the slash-filled box 1104 represents a time domain resource for receiving the reference signal using the spatial filtering parameter 1102.

In Embodiment 11, the reference signal occupies a plurality of multicarrier symbols of the frame in time domain; each of a plurality of spatial filtering parameters is used for receiving the reference signal on at least one multicarrier symbol.

In an embodiment, in the time domain resource corresponding to the slash-filled box 1103, the reference signal is received using the spatial filtering parameter 1101; and in the time domain resource corresponding to the slash-filled box 1104, the reference signal is received using the spatial filtering parameter 1102.

In an embodiment, each slash-filled box represents a multicarrier symbol, and a time domain resource for receiving the reference signal using each of the plurality of spatial filtering parameters is only one multicarrier symbol.

In an embodiment, each slash-filled box represents more than one multicarrier symbol, and the time domain resource for receiving the reference signal using each of the plurality of spatial filtering parameters is more than one multicarrier symbol.

In an embodiment, each slash-filled box represents more than one multicarrier symbol, and the time domain resource for receiving the reference signal using each of the plurality of spatial filtering parameters is M1 multicarrier symbols.

In an embodiment, this embodiment does not limit the plurality of multicarrier symbols to belong to a downlink frame.

In an embodiment, this embodiment does not limit a quantity of the plurality of multicarrier symbols.

In an embodiment, this embodiment does not limit a quantity of the at least one multicarrier symbol.

In an embodiment, this embodiment does not limit locations of the plurality of multicarrier symbols in the downlink frame.

### Embodiment 12

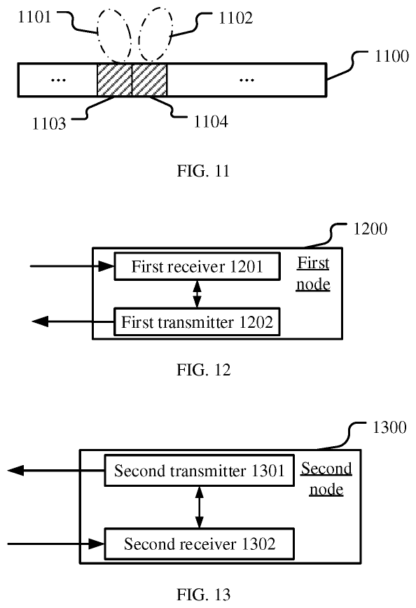

Embodiment 12 illustrates a block diagram of a structure of a processing apparatus in a first node according to an embodiment of this disclosure, as shown in FIG. 12. In FIG. 12, the processing apparatus 1200 in the first node includes a first receiver 1201 and a first transmitter 1202.

The first receiver 1201 measures a reference signal using a plurality of spatial filtering parameters separately.

The first transmitter 1202 sends a first wireless signal, where a first spatial filtering parameter is used for sending the first wireless signal.

In Embodiment 12, the first spatial filtering parameter is one of the plurality of spatial filtering parameters, and reception quality measured on a target path using the plurality of spatial filtering parameters is used for determining the first spatial filtering parameter.

In an embodiment, the target path is after a first path measured using the plurality of spatial filtering parameters.

In an embodiment, reception quality measured on a first candidate path set using the plurality of spatial filtering parameters is used for determining the first spatial filtering parameter, the first candidate path set includes a plurality of paths, and the target path is one of the plurality of paths.

In an embodiment, reception quality measured on the target path using the first spatial filtering parameter is not lower than a specific threshold.

In an embodiment, the reference signal occupies a plurality of multicarrier symbols in time domain, and each of the plurality of spatial filtering parameters is used for receiving the reference signal on at least one multicarrier symbol.

In an embodiment, the first transmitter sends first measurement information. The first measurement information includes a difference between a reception timing of the reference signal and a transmission timing of the first wireless signal.

In an embodiment, the first receiver 1201 includes at least one of the antenna 452, the receiver 454, the multi-antenna receive processor 458, the receive processor 456, the controller/processor 459, the memory 460, or the data source 467 in FIG. 4 of this disclosure.

In an embodiment, the first receiver 1201 includes at least the antenna 452 and the receiver 454 in FIG. 4 of this disclosure.

In an embodiment, the first transmitter 1202 includes at least one of the antenna 452, the transmitter 454, the multi-antenna transmit processor 457, the transmit processor 468, the controller/processor 459, the memory 460, or the data source 467 in FIG. 4 of this disclosure.

In an embodiment, the first transmitter 1202 includes at least the antenna 452 and the transmitter 454 in FIG. 4 of this disclosure.

### Embodiment 13

Embodiment 13 illustrates a block diagram of a structure of a processing apparatus in a second node according to an embodiment of this disclosure, as shown in FIG. 13. In FIG. 13, the processing apparatus 1300 in the second node includes a second transmitter 1301 and a second receiver 1302.

The second receiver 1302 receives a first wireless signal, where a first spatial filtering parameter is used by a sender of the first wireless signal for sending the first wireless signal.

In Embodiment 13, the sender of the first wireless signal measures a reference signal using a plurality of spatial filtering parameters separately, the first spatial filtering parameter is one of the plurality of spatial filtering parameters, and reception quality measured on a target path using the plurality of spatial filtering parameters is used by the sender of the first wireless signal for determining the first spatial filtering parameter.

In an embodiment, the target path is after a first path measured using the plurality of spatial filtering parameters.

In an embodiment, reception quality measured on a first candidate path set using the plurality of spatial filtering parameters is used for determining the first spatial filtering parameter, the first candidate path set includes a plurality of paths, and the target path is one of the plurality of paths.

In an embodiment, reception quality measured on the target path using the first spatial filtering parameter is not lower than a specific threshold.

In an embodiment, the reference signal occupies a plurality of multicarrier symbols in time domain, and each of the plurality of spatial filtering parameters is used for receiving the reference signal on at least one multicarrier symbol.

In an embodiment, the second receiver 1302 receives first measurement information. The first measurement information includes a difference between a reception timing of the reference signal and a transmission timing of the first wireless signal.

In an embodiment, the second transmitter 1301 sends the reference signal.

In an embodiment, the second transmitter 1301 sends second measurement information. The second measurement information includes a difference between a reception timing of a reception frame and a transmission timing of a transmission frame, and the reception frame includes the first wireless signal.

In an embodiment, the second transmitter 1301 includes at least one of the antenna 420, the transmitter 418, the multi-antenna transmit processor 471, the transmit processor 416, the controller/processor 475, or the memory 476 in FIG. 4 of this disclosure.

In an embodiment, the second transmitter 1301 includes at least the antenna 420 and the transmitter 418 in FIG. 4 of this disclosure.

In an embodiment, the second receiver 1302 includes at least one of the antenna 420, the receiver 418, the multi-antenna receive processor 472, the receive processor 470, the controller/processor 475, or the memory 476 in FIG. 4 of this disclosure.

In an embodiment, the second receiver 1302 includes at least the antenna 420 and the receiver 418 in FIG. 4 of this disclosure.

A person of ordinary skill in the art may understand that all or part of the steps of the foregoing methods may be implemented by a program instructing relevant hardware. The program may be stored in a computer-readable storage medium, such as a read-only memory, a hard disk, or an optical disk. Optionally, all or part of the steps of the foregoing embodiments may also be implemented using one or more integrated circuits. Correspondingly, each module unit in the foregoing embodiments may be implemented in a form of hardware, or may be implemented in a form of a software functional module. This disclosure is not limited to any specific combination of software and hardware. The user equipment, the terminal, and the UE in this disclosure include, but are not limited to, drones, communication modules on drones, remote control aircrafts, flying machines, small aircrafts, mobile phones, tablet computers, notebook computers, vehicle-mounted communication devices, wireless sensors, network cards, internet of things terminals, RFID terminals, NB-IoT terminals, machine type communication (MTC) terminals, enhanced MTC (eMTC) terminals, data cards, low-cost mobile phones, low-cost tablet computers, and other wireless communication devices. The base station or system device in this disclosure includes, but is not limited to, a macro cellular base station, a micro cellular base station, a femtocell, a relay base station, a gNB (NR NodeB) NR NodeB, a Transmitter Receiver Point (transmission reception point, TRP), and another wireless communication device.

The foregoing descriptions are merely embodiments of this disclosure, but are not intended to limit the protection scope of this disclosure. Any modification, equivalent replacement, improvement, and the like made within the spirit and principles of this disclosure shall all fall within the protection scope of this disclosure.

What is claimed is:

1. A first node used for wireless communication, comprising:
a first receiver configured to measure a reference signal using a plurality of spatial filtering parameters separately; and
a first transmitter configured to send a first wireless signal using a first spatial filtering parameter, wherein the first spatial filtering parameter is one of the plurality of spatial filtering parameters, and wherein reception quality measured on a target path using the plurality of spatial filtering parameters is used for determining the first spatial filtering parameter.

2. The first node of claim 1, wherein the target path is after a first path measured using the plurality of spatial filtering parameters.

3. The first node of claim 1, wherein reception quality measured on a first candidate path set using the plurality of spatial filtering parameters is used for determining the first spatial filtering parameter, wherein the first candidate path set comprises a plurality of paths, and wherein the target path is one of the plurality of paths.

4. The first node of claim 1, wherein reception quality measured on the target path using the first spatial filtering parameter is not lower than a specific threshold.

5. The first node of claim 1, wherein the reference signal occupies a plurality of multicarrier symbols in time domain, and wherein each of the plurality of spatial filtering parameters is used for receiving the reference signal on at least one multicarrier symbol.

6. The first node of claim 1, wherein the first transmitter is configured to send first measurement information comprising a difference between a reception timing of the reference signal and a transmission timing of the first wireless signal.

7. A method in a first node used for wireless communication, comprising:
measuring a reference signal using a plurality of spatial filtering parameters separately; and
sending a first wireless signal using a first spatial filtering parameter, wherein the first spatial filtering parameter is one of the plurality of spatial filtering parameters, and wherein reception quality measured on a target path using the plurality of spatial filtering parameters is used for determining the first spatial filtering parameter.

8. The method of claim 7, wherein the target path is after a first path measured using the plurality of spatial filtering parameters.

9. The method of claim 7, wherein reception quality measured on a first candidate path set using the plurality of spatial filtering parameters is used for determining the first spatial filtering parameter, wherein the first candidate path set comprises a plurality of paths, and wherein the target path is one of the plurality of paths.

10. The method of claim 7, wherein reception quality measured on the target path using the first spatial filtering parameter is not lower than a specific threshold.

11. The method of claim 7, wherein the reference signal occupies a plurality of multicarrier symbols in time domain, and wherein each of the plurality of spatial filtering parameters is used for receiving the reference signal on at least one multicarrier symbol.

12. The method of claim 7, further comprising sending first measurement information comprising a difference between a reception timing of the reference signal and a transmission timing of the first wireless signal.

13. A method in a second node used for wireless communication, comprising:
receiving a first wireless signal sent according to a first spatial filtering parameter, wherein a process of determining the first spatial filtering parameter comprises:
measuring a reference signal using a plurality of spatial filtering parameters separately, wherein the first spatial filtering parameter is one of the plurality of spatial filtering parameters; and
measuring reception quality on a target path using the plurality of spatial filtering parameters to determine the first spatial filtering parameter.

14. The method of claim 13, wherein the target path is after a first path measured using the plurality of spatial filtering parameters.

15. The method of claim 13, wherein reception quality measured on a first candidate path set using the plurality of spatial filtering parameters is used for determining the first spatial filtering parameter, wherein the first candidate path set comprises a plurality of paths, and wherein the target path is one of the plurality of paths.

16. The method of claim 13, wherein reception quality measured on the target path using the first spatial filtering parameter is not lower than a specific threshold.

17. The method of claim 13, wherein the reference signal occupies a plurality of multicarrier symbols in time domain, and wherein each of the plurality of spatial filtering parameters is used for receiving the reference signal on at least one multicarrier symbol.

18. The method of claim 13, further comprising receiving first measurement information, wherein the first measurement information comprises a difference between a reception timing of the reference signal and a transmission timing of the first wireless signal.

19. The method of claim 13, further comprising sending the reference signal.

20. The method of claim 13, further comprising sending second measurement information, wherein the second measurement information includes a difference between a reception timing of a reception frame and a transmission timing of a transmission frame, wherein the reception frame includes the first wireless signal, and wherein the transmission frame is closest to the reception frame in time.
